(19) United States
(12) Patent Application Publication
(10) Pub. No.: US 2026/0011914 A1
(43) Pub. Date: Jan. 8, 2026

(54) SWITCHING ELEMENT AND PLANAR ANTENNA

(71) Applicant: NEC Corporation, Tokyo (JP)

(72) Inventors: Kohei YOSHIDA, Tokyo (JP); Fujio OKUMURA, Kanagawa (JP)

(73) Assignee: NEC Corporation, Tokyo (JP)

(21) Appl. No.: 19/240,280

(22) Filed: Jun. 17, 2025

(30) Foreign Application Priority Data
Jul. 5, 2024 (JP) 2024-108574

(51) Int. Cl. H01Q 3/32; H01Q 3/24

(52) U.S. Cl. CPC H01Q 3/32; H01Q 3/24

(57) ABSTRACT

A switching element includes a phase transition layer that includes a substance that undergoes a metal-insulator phase transition and is arranged on signal lines through which signals to be transmitted and received propagate, a heat conduction layer that is an insulator having a thermal conductivity higher than a thermal conductivity of the phase transition layer and is formed on a surface of the phase transition layer, and a heat generation element that has a rectangular shape having a long side along a direction perpendicular to an extension direction of the signal lines and a short side shorter than a side length of the phase transition layer, and that is thermally connected to the phase transition layer and the heat conduction layer.

### TECHNICAL FIELD

The present disclosure relates to a switching element and a planar antenna.

### BACKGROUND ART

A metal-insulator phase transition element (also referred to as a phase transition element) includes a substance that undergoes a metal-insulator phase transition in the vicinity of a phase transition temperature. For example, a vanadium dioxide is a substance that undergoes the metal-insulator phase transition at around 67 degrees Celsius. A switching element using the metal-insulator phase transition can be achieved by using a heat generation element that controls a temperature of the phase transition element. A phased array antenna can be configured by arranging such switching elements in an array shape in association with a patch antenna. For example, a phased array antenna capable of transmitting a radio wave in a desired direction can be achieved by controlling temperatures of a plurality of the phase transition elements individually using a thin film transistor circuit (TFT circuit) including a thin film transistor (TFT) as a drive circuit.

PTL 1 (JP 2007-224390 A) discloses a switching element including a vanadium dioxide thin film. The switching element of PTL 1 includes a substrate on which the vanadium dioxide thin film is manufactured, and gate electrodes as a pair of electrodes provided on the vanadium dioxide thin film to be separated from each other.

### SUMMARY

PTL 1 discloses an example in which the vanadium dioxide thin film is formed on an α-alumina substrate. The α-alumina substrate is a substrate suitable for crystallizing a vanadium dioxide. The α-alumina substrate has a higher thermal conductivity than that of the vanadium dioxide. Therefore, when a size of a heat generation element is too small relative to a vanadium dioxide layer, heat applied to the vanadium dioxide layer easily escapes to the α-alumina substrate, and it is difficult to efficiently heat the vanadium dioxide layer. When the size of the heat generation element is increased, the vanadium dioxide layer can be efficiently heated, and therefore, the vanadium dioxide layer can be efficiently subjected to a phase transition to a metal phase. However, when the size of the heat generation element is excessively increased, the heat generation element and a signal line are close to each other, and as a result, high-frequency coupling easily occurs. Therefore, it is needed to efficiently perform the phase transition of the vanadium dioxide thin film (phase transition layer) without excessively increasing the size of the heat generation element.

An object of the present disclosure is to provide a switching element and a planar antenna capable of efficiently performing a phase transition of a phase transition layer including a substance that undergoes a metal-insulator phase transition.

A switching element of an aspect of the present disclosure includes a phase transition layer that includes a substance that undergoes a metal-insulator phase transition and is arranged on signal lines through which signals to be transmitted and received propagate, a heat conduction layer that is an insulator having a thermal conductivity higher than a thermal conductivity of the phase transition layer and is formed on a surface of the phase transition layer, and a heat generation element that has a rectangular shape having a long side along a direction perpendicular to an extension direction of the signal lines and a short side shorter than a side length of the phase transition layer, and that is thermally connected to the phase transition layer and the heat conduction layer.

A planar antenna of an aspect of the present disclosure includes an antenna substrate on which an antenna array and a switching element are arranged, the antenna array including a plurality of patch antennas arranged in an array shape, the switching element being associated with each of the plurality of patch antennas, and a temperature control substrate on which a thin film transistor circuit that controls a temperature of the switching element associated with each of the plurality of patch antennas is arranged, and the switching element includes a phase transition layer that includes a substance that undergoes a metal-insulator phase transition and is arranged on signal lines through which signals to be transmitted and received propagate, a heat conduction layer that is an insulator having a thermal conductivity higher than a thermal conductivity of the phase transition layer and is formed on a surface of the phase transition layer, and a heat generation element that has a rectangular shape having a long side along a direction perpendicular to an extension direction of the signal lines and a short side shorter than a side length of the phase transition layer, and that is thermally connected to the phase transition layer and the heat conduction layer.

According to the present disclosure, it is possible to provide a switching element and a planar antenna capable of efficiently performing a phase transition of a phase transition layer including a substance that undergoes a metal-insulator phase transition.

### BRIEF DESCRIPTION OF THE DRAWINGS

FIG. 1 is a conceptual diagram illustrating an example of a configuration of a switching element in the present disclosure;

FIG. 2 is a conceptual diagram illustrating an example of the configuration of the switching element in the present disclosure;

FIG. 3 is a conceptual diagram illustrating an example of the configuration of the switching element in the present disclosure;

FIG. 4 is a conceptual diagram illustrating an example of the configuration of the switching element in the present disclosure;

FIG. 5 is a conceptual diagram illustrating an example of a configuration of a switching element in the present disclosure;

FIG. 6 is a conceptual diagram illustrating an example of the configuration of the switching element in the present disclosure;

FIG. 7 is a conceptual diagram illustrating an example of the configuration of the switching element in the present disclosure;

FIG. 8 is a conceptual diagram illustrating an example of a configuration of a switching element in the present disclosure;

FIG. 9 is a conceptual diagram illustrating an example of the configuration of the switching element in the present disclosure;

FIG. 10 is a conceptual diagram illustrating an example of the configuration of the switching element in the present disclosure;

FIG. 11 is a conceptual diagram illustrating an example of the configuration of the switching element in the present disclosure;

FIG. 12 is a conceptual diagram illustrating an example of a configuration of a switching element in the present disclosure;

FIG. 13 is a conceptual diagram illustrating an example of the configuration of the switching element in the present disclosure;

FIG. 14 is a conceptual diagram illustrating an example of the configuration of the switching element in the present disclosure;

FIG. 15 is a conceptual diagram illustrating an example of the configuration of the switching element in the present disclosure;

FIG. 16 is a conceptual diagram illustrating an example of the configuration of the switching element in the present disclosure;

FIG. 17 is a conceptual diagram illustrating an example of the configuration of the switching element in the present disclosure;

FIG. 18 is a conceptual diagram illustrating an example of the configuration of the switching element in the present disclosure;

FIG. 19 is a conceptual diagram illustrating an example of the configuration of the switching element in the present disclosure;

FIG. 20 is a conceptual diagram illustrating an example of an extension structure of a phase shifter in the present disclosure;

FIG. 21 is a conceptual diagram illustrating an example of the extension structure of the phase shifter in the present disclosure;

FIG. 22 is a conceptual diagram illustrating an example of the extension structure of the phase shifter in the present disclosure;

FIG. 23 is a conceptual diagram illustrating an example of heat conduction in the extension structure of the phase shifter in the present disclosure;

FIG. 24 is a conceptual diagram illustrating an example of the extension structure of the phase shifter in the present disclosure;

FIG. 25 is a conceptual diagram illustrating an example of the extension structure of the phase shifter in the present disclosure;

FIG. 26 is a conceptual diagram illustrating an example of the extension structure of the phase shifter in the present disclosure;

FIG. 27 is a conceptual diagram illustrating an example of the heat conduction in the extension structure of the phase shifter in the present disclosure;

FIG. 28 is a conceptual diagram illustrating an example of a configuration of an antenna device in the present disclosure;

FIG. 29 is a conceptual diagram illustrating a cross section of a portion of a planar antenna included in the antenna device in the present disclosure;

FIG. 30 is a block diagram illustrating an example of the configuration of the antenna device in the present disclosure;

FIG. 31 is a conceptual diagram illustrating an example of a configuration of a switching element in the present disclosure; and

FIG. 32 is a block diagram illustrating an example of a hardware configuration that executes control in the present disclosure.

### EXAMPLE EMBODIMENT

Hereinafter, modes for carrying out the present disclosure will be described with reference to the drawings. In the present disclosure, the drawings used in description of each example embodiment are associated with one or more example embodiments. Elements included in each drawing may apply to one or more example embodiments. The example embodiments described below have technically preferable limitations for carrying out the present disclosure, but the scope of the disclosure is not limited to the followings. In all the drawings used in the following description of the example embodiments, the same reference signs are given to similar parts unless otherwise specified. In the following example embodiments, repeated description of similar configurations and operations may be omitted.

### First Example Embodiment

First, a switching element in a first example embodiment will be described with reference to the drawings. The switching element of the present disclosure is one of metal-insulator phase transition elements (also referred to as phase transition elements) including a substance that undergoes a metal-insulator phase transition. For example, the switching element according to the present disclosure is also referred to as a phase transition switching element, a switching element, a phase transition switch, or the like. Hereinafter, an example in which a vanadium dioxide is used as the substance that undergoes the metal-insulator phase transition will be described. The vanadium dioxide undergoes the metal-insulator phase transition at around 67 degrees Celsius. A substance that undergoes the metal-insulator phase transition other than the vanadium dioxide may be applied to the switching element of the present disclosure.

For example, the switching element of the present example embodiment is mounted on a planar antenna including a plurality of patch antennas. By mounting the switching element of the present example embodiment on each of the plurality of patch antennas, a phased array antenna that transmits a radio wave having directivity can be configured. Such a planar antenna is used for transmission/reception of electromagnetic waves in a high frequency band predicted to be applied to mobile communication of Beyond 5 Generation (B5G) following 5 Generation (5G). The switching element of the present example embodiment is not limited to be mounted on the planar antenna, and can be mounted on any device.

### (Configuration)

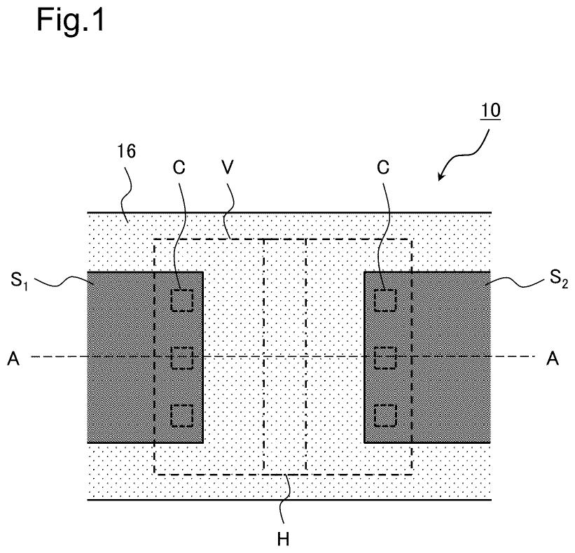

FIG. 1 is a conceptual diagram illustrating an example of a configuration of the switching element in the present disclosure. FIG. 1 is a plan view of the switching element viewed from an upper viewpoint. A switching element 10 includes a phase transition layer V and a heat generation element H. When viewed from the upper viewpoint, the phase transition layer V and the heat generation element H are arranged below an insulation layer 16. A formation region of the phase transition layer V is indicated by a broken line. A formation region of the heat generation element H is indicated by an alternate long and short dash line. The heat generation element H is arranged on an upper surface of the phase transition layer V. A heat conduction layer (described later) is arranged on a lower surface of the phase transition layer V. The phase transition layer V is electrically connected to a first signal line S₁ and a second signal line S₂ via connection ends C. The first signal line S₁ and the second signal line S₂ are collectively referred to as the signal lines.

The phase transition layer V includes a vanadium dioxide that undergoes a phase transition from an insulation phase to a metal phase at a phase transition temperature. The phase transition layer V is a phase transition switching element using the phase transition of the insulation phase-metal phase of the vanadium dioxide. That is, the switching element 10 is an example of the phase transition element using the metal-insulator phase transition. The phase transition layer V may include a material other than the vanadium dioxide. For example, the phase transition layer V may include a material such as a composite oxide including the vanadium dioxide or an oxide including a 3d transition metal. It is sufficient that a material having a transition temperature according to an environmental temperature is applied to the phase transition layer V. For example, a material that undergoes a phase transition at a usable temperature in a use environment of the planar antenna is applied to the phase transition layer V.

For example, the phase transition layer V may include a vanadium dioxide to which no additive element is added. In that case, a ratio between oxygen and vanadium included in the vanadium dioxide is adjusted to a ratio at which the phase transition of the insulation phase-metal phase occurs. For example, the additive element may be added to the vanadium dioxide included in the phase transition layer V. For example, when the additive element such as tungsten, magnesium, tantalum, iron, molybdenum, fluorine, or niobium is added to the vanadium dioxide, the phase transition temperature decreases. For example, when chromium, aluminum, or germanium is added to the vanadium dioxide, the phase transition temperature increases.

The vanadium dioxide is the insulation phase at a temperature lower than the phase transition temperature. Therefore, at the temperature lower than the phase transition temperature, the phase transition layer V is an insulator, and the switching element 10 is in an off state. The vanadium dioxide is the metal phase at a temperature higher than the phase transition temperature. Therefore, at the temperature higher than the phase transition temperature, the phase transition layer V is the metal phase, and the switching element 10 is in an on state. A resistance change in the phase transition of the insulation phase-metal phase of the vanadium dioxide indicates hysteresis characteristics. Therefore, in consideration of the hysteresis characteristics, the temperature of the phase transition layer V is adjusted in such a way as to cross the phase transition temperature.

For example, the phase transition layer V is formed by using a sputtering method or a pulsed laser method having metal vanadium or the vanadium dioxide as a target. For example, the phase transition layer V may be formed by using a sol-gel method, an inkjet method, screen printing, or the like.

In the present example embodiment, three configuration examples will be described regarding the switching element 10. Hereinafter, the configuration examples of the switching element 10 are distinguished by adding a hyphen (-) and a number after a reference sign (10).

### Configuration Example 1-1

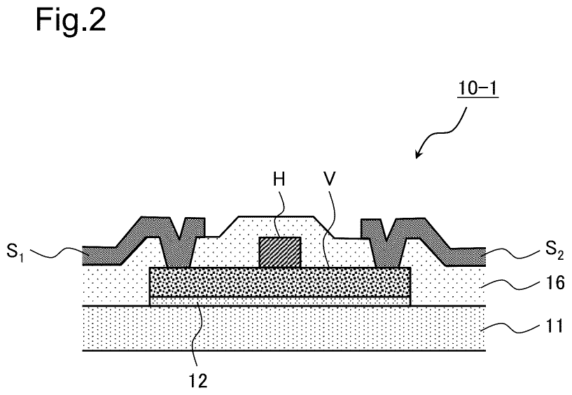

FIG. 2 is a conceptual diagram illustrating an example of the configuration (Configuration Example 1-1) of the switching element in the present disclosure. FIG. 2 is a cross-sectional view of the switching element cut along a cutting line A-A in FIG. 1.

A switching element 10-1 includes a substrate 11, a heat conduction layer 12, the phase transition layer V, the heat generation element H, and the insulation layer 16. The substrate 11, the heat conduction layer 12, the phase transition layer V, and the heat generation element H are covered with the insulation layer 16. The phase transition layer V is electrically connected to the first signal line S₁ and the second signal line S₂ via openings formed in the insulation layer 16. For example, the first signal line S₁ and the second signal line S₂ include metal such as copper or aluminum.

The substrate 11 is an insulator (dielectric). The substrate 11 has a thermal conductivity lower than that of the phase transition layer V. The substrate 11 includes a material having a low dielectric loss. The substrate 11 preferably includes a raw material having high insulating property and a low dielectric loss, such as a ceramic material or glass. The substrate 11 may include a polymer or a synthetic material. The lower the dielectric loss of the substrate 11, the more effectively electromagnetic waves such as high frequency waves and microwaves can be controlled.

The heat conduction layer 12 is arranged on an upper surface of the substrate 11. The phase transition layer V is arranged on an upper surface of the heat conduction layer 12. The heat conduction layer 12 includes a material having a higher thermal conductivity than those of the substrate 11 and the phase transition layer V. The material of the heat conduction layer 12 is not limited as long as it includes the material having the higher thermal conductivity than that of the substrate 11. For example, the heat conduction layer 12 includes α-alumina. Since the α-alumina has high lattice matching with the vanadium dioxide, it is easy to crystallize the vanadium dioxide. Therefore, an α-alumina substrate is a substrate suitable for crystallizing the vanadium dioxide. For example, the heat conduction layer 12 may include silicon carbide. The silicon carbide has a crystal system whose thermal conductivity is comparable to that of metal.

The phase transition layer V is arranged on the upper surface of the heat conduction layer 12. The heat generation element H is arranged on the upper surface of the phase transition layer V. The phase transition layer V undergoes the phase transition from the insulation phase to the metal phase by heat generation of the heat generation element H. The phase transition layer V is electrically connected to the first signal line S₁ and the second signal line S₂ via the connection ends C. The phase transition layer V is arranged between the first signal line S₁ and the second signal line S₂ and functions as a switch.

In a case where the switching element 10-1 is mounted on the planar antenna, the first signal line S₁ is connected to a signal source (not illustrated) via a phase shift wiring (not illustrated). For example, the first signal line S₁ is configured as a line through which a phase-shifted signal is propagated by the phase shift wiring. For example, the second signal line S₂ is configured as a line for propagating the phase-shifted signal to the patch antenna, and extends below the patch antenna. A layer in which the phase transition layer V, the first signal line S₁, and the second signal line S₂ are arranged forms a phase shift layer. For example, a signal reaching the second signal line S₂ propagates to the patch antenna P by electromagnetic coupling. For example, the signal reaching the second signal line S₂ may propagate to the patch antenna via a conductor such as a via.

The heat generation element H is arranged on the upper surface of the phase transition layer V. The heat generation element H has an elongated rectangular shape along a direction perpendicular to an extension direction of the first signal line S₁ and the second signal line S₂. That is, the heat generation element H is smaller than the phase transition layer V. A temperature of the heat generation element His controlled according to selection via a TFT circuit (not illustrated). The heat generation element H is connected to a drive circuit constituting the TFT circuit by a temperature control line. A TFT wiring includes a plurality of selection lines and a plurality of data lines. When the drive circuit connected to the heat generation element H is selected, the heat generation element H generates heat. The heat of the heat generation element H is conducted to the phase transition layer V arranged on a lower surface of the heat generation element H. The resistance change in the phase transition of the insulation phase-metal phase of the vanadium dioxide indicates the hysteresis characteristics. Therefore, in consideration of the hysteresis characteristics, the temperature of the heat generation element His controlled in such a way that the temperature of the phase transition layer V crosses the phase transition temperature.

The heat generation element H includes a raw material having a large electric resistance that easily generates heat by energization. For example, the heat generation element H includes a raw material including a nickel-chromium alloy, a chromium-iron-aluminum alloy, or the like. The selected heat generation element H generates heat to the temperature at which the vanadium dioxide included in the phase transition layer V undergoes the phase transition to the metal phase. In a state where the heat generation element H does not generate heat, the vanadium dioxide included in the phase transition layer V is in the insulation phase state. When the vanadium dioxide included in the phase transition layer V is in the insulation phase state, the switching element 10-1 is in an off state.

The insulation layer 16 covers the substrate 11, the heat conduction layer 12, the phase transition layer V, and the heat generation element H. The insulation layer 16 opens above two opposing ends of the phase transition layer V. The connection ends C of the first signal line S₁ and the second signal line S₂ are electrically connected to the phase transition layer V via the openings formed in the insulation layer 16. For example, the insulation layer 16 includes an insulation material such as silicon dioxide. A thermal conductivity of the insulation layer 16 is about the same as that of the substrate 11. That is, the insulation layer 16 has the lower thermal conductivity than that of the phase transition layer V.

When the heat generation element H generates heat according to the selection via the TFT circuit, the heat of the heat generation element H is conducted to the phase transition layer V. The heat conducted to the phase transition layer V is conducted to the heat conduction layer 12 arranged on the lower surface of the phase transition layer V. Since the heat conduction layer 12 has the higher thermal conductivity than that of the phase transition layer V, the heat is more efficiently conducted than in the phase transition layer V. The heat conducted in the heat conduction layer 12 is conducted to the phase transition layer V arranged on the upper surface. As a result, the phase transition layer V is uniformly heated via the heat conduction layer 12 arranged on the lower surface. The heat conducted to the phase transition layer V is also conducted to the first signal line S₁ and the second signal line S₂ via the connection ends C. When the phase transition temperature is exceeded, the vanadium dioxide undergoes the phase transition from the insulation phase to the metal phase. When the vanadium dioxide undergoes the phase transition to the metal phase, the switching element 10-1 transitions to an on state. When the heat generation of the deselected heat generation element H stops and the temperature of the vanadium dioxide falls below the phase transition temperature, the vanadium dioxide undergoes a phase transition from the metal phase to the insulation phase. When the vanadium dioxide undergoes the phase transition to the insulation phase, the switching element 10-1 transitions to the off state.

In order to efficiently heat the phase transition layer V, it is preferable to increase a contact area between the phase transition layer V and a heating element. However, when the heating element is too close to the first signal line S₁ and the second signal line S₂, high-frequency coupling easily occurs. When the thermal conductivity of the substrate 11 is made higher than that of the phase transition layer V, the phase transition layer V can be uniformly heated from the lower surface. However, when the thermal conductivity of the substrate 11 is higher than that of the phase transition layer V, heat desired to be conducted to the phase transition layer V is easily dissipated via the substrate 11.

In the present configuration example, heat is conducted to the phase transition layer V via the heat conduction layer 12 having the higher thermal conductivity than that of the phase transition layer V. In the present configuration example, since the heat conduction layer 12 is arranged between the substrate 11 having the lower thermal conductivity than that of the phase transition layer V and the phase transition layer V, the heat hardly escapes to the substrate 11. Therefore, according to the present configuration example, the phase transition layer V can be efficiently heated as compared with a case where the heat conduction layer 12 is not provided. In the present configuration example, since the heat hardly escapes to the substrate 11, a size of the heat generation element H can be reduced. Therefore, according to the present configuration example, by forming the heat generation element H in the elongated rectangular shape, high-frequency coupling between the first signal line S₁ and the second signal line S₂ and the heat generation element H hardly occurs.

### Configuration Example 1-2

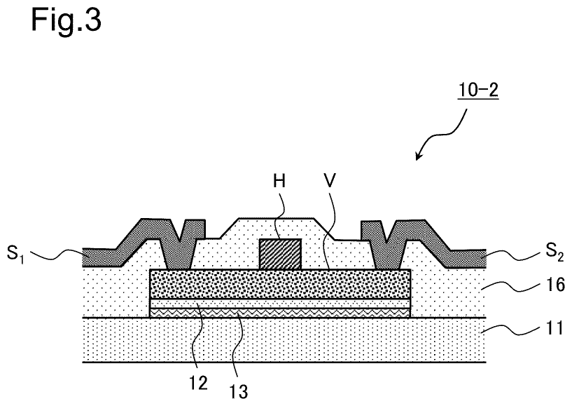

FIG. 3 is a conceptual diagram illustrating an example of the configuration (Configuration Example 1-2) of the switching element in the present disclosure. FIG. 3 is a cross-sectional view of the switching element cut along the cutting line A-A in FIG. 1. The present configuration example is different from Configuration Example 1-1 in including a heat conduction promotion layer. Hereinafter, description of a configuration similar to that of Configuration Example 1-1 will be omitted.

A switching element 10-2 includes the substrate 11, the heat conduction layer 12, a heat conduction promotion layer 13, the phase transition layer V, the heat generation element H, and the insulation layer 16. The substrate 11, the heat conduction layer 12, the heat conduction promotion layer 13, the phase transition layer V, and the heat generation element H are covered with the insulation layer 16. The phase transition layer V is electrically connected to the first signal line S₁ and the second signal line S₂. For example, the first signal line S₁ and the second signal line S₂ include metal such as copper or aluminum.

The heat conduction promotion layer 13 is arranged on the upper surface of the substrate 11. The heat conduction layer 12 is arranged on an upper surface of the heat conduction promotion layer 13. The heat conduction promotion layer 13 includes a material having a higher thermal conductivity than those of the substrate 11 and the heat conduction layer 12. That is, the heat conduction promotion layer 13 has the higher thermal conductivity than those of the substrate 11 and the heat conduction layer 12. The material of the heat conduction promotion layer 13 is not limited as long as it includes the material having the higher thermal conductivity than those of the substrate 11 and the heat conduction layer 12. For example, the heat conduction promotion layer 13 includes silicon carbide. The silicon carbide has a crystal system whose thermal conductivity is comparable to that of metal.

The heat conduction layer 12 is arranged on the upper surface of the heat conduction promotion layer 13. The phase transition layer V is arranged on an upper surface of the heat conduction layer 12. The heat conduction layer 12 includes the material having the higher thermal conductivity than those of the substrate 11 and the phase transition layer V. The heat conduction layer 12 includes the material having the lower thermal conductivity than that of the heat conduction promotion layer 13. The material of the heat conduction layer 12 is not limited as long as it includes the material having the higher thermal conductivity than that of the substrate 11 and having the lower thermal conductivity than that of the heat conduction promotion layer 13. For example, the heat conduction layer 12 includes sapphire (alumina). When the sapphire is used as a base, crystallinity of the vanadium dioxide is improved, and therefore the sapphire is suitable as the material of the heat conduction layer 12. In this manner, in a case where the sapphire is used for the heat conduction layer 12, the heat conduction layer 12 functions as a crystallinity improvement layer of the vanadium dioxide. As compared to the silicon carbide, the sapphire is advantageous in crystal growth of the vanadium dioxide. Therefore, when the sapphire functions as the crystallinity improvement layer and the silicon carbide functions as the heat conduction promotion layer (heat conduction layer), the phase transition layer V can be efficiently heated.

The phase transition layer V is arranged on the upper surface of the heat conduction layer 12. The heat generation element H is arranged on the upper surface of the phase transition layer V. The phase transition layer V undergoes the phase transition from the insulation phase to the metal phase by heat generation of the heat generation element H. The phase transition layer V is electrically connected to the first signal line S₁ and the second signal line S₂ via the connection ends C. The phase transition layer V is arranged between the first signal line S₁ and the second signal line S₂ and functions as a switch.

When the heat generation element H generates heat according to the selection via the TFT circuit, the heat of the heat generation element H is conducted to the vanadium dioxide included in the phase transition layer V. The heat conducted to the phase transition layer V is conducted to the heat conduction layer 12 arranged on the lower surface of the phase transition layer V. Since the heat conduction layer 12 has the higher thermal conductivity than that of the phase transition layer V, the heat is more efficiently conducted than in the phase transition layer V. The heat conducted to the heat conduction layer 12 is further conducted to the heat conduction promotion layer 13 arranged on a lower surface of the heat conduction layer 12. Since the heat conduction promotion layer 13 has the higher thermal conductivity than that of the heat conduction layer 12, the heat is more efficiently conducted than in the heat conduction layer 12. The heat conducted in the heat conduction promotion layer 13 is conducted to the heat conduction layer 12 arranged on the upper surface. The heat conducted in the heat conduction layer 12 and the heat conducted from the heat conduction promotion layer 13 to the heat conduction layer 12 are conducted to the phase transition layer V arranged on the upper surface. As a result, the phase transition layer V is uniformly heated via the heat conduction layer 12 and the heat conduction promotion layer 13 arranged on the lower surface. The heat conducted to the phase transition layer V is also conducted to the first signal line S₁ and the second signal line S₂ via the connection ends C. When the temperature of the vanadium dioxide exceeds the phase transition temperature, the vanadium dioxide undergoes the phase transition from the insulation phase to the metal phase. When the vanadium dioxide undergoes the phase transition to the metal phase, the switching element 10-2 transitions to an on state. When the heat generation of the deselected heat generation element H stops and the temperature of the vanadium dioxide falls below the phase transition temperature, the vanadium dioxide undergoes the phase transition from the metal phase to the insulation phase. When the vanadium dioxide undergoes the phase transition to the insulation phase, the switching element 10-2 transitions to an off state.

In the present configuration example, heat is conducted to the phase transition layer V via the heat conduction layer 12 and the heat conduction promotion layer 13 having the higher thermal conductivities than that of the phase transition layer V. In the present configuration example, since the heat conduction layer 12 and the heat conduction promotion layer 13 are arranged between the substrate 11 having the lower thermal conductivity than that of the phase transition layer V and the phase transition layer V, the heat hardly escapes to the substrate 11. In the present configuration example, since the heat conduction promotion layer 13 is included, the phase transition layer V can be more efficiently heated than in Configuration Example 1-1. In the present configuration example, since the heat hardly escapes to the substrate 11, the size of the heat generation element H can be made smaller than in Configuration Example 1-1. Therefore, according to the present configuration example, high-frequency coupling between the first signal line S₁ and the second signal line S₂ and the heat generation element H is less likely to occur than in Configuration Example 1-1.

In the present configuration example, an example has been described in which the heat conduction layer 12 is arranged on the lower surface of the phase transition layer V and the heat conduction promotion layer 13 is arranged on the lower surface of the heat conduction layer 12. For example, the heat conduction promotion layer 13 may be arranged on the lower surface of the phase transition layer V, and the heat conduction layer 12 may be arranged on the lower surface of the heat conduction promotion layer 13. For example, a heat conduction layer other than the heat conduction layer 12 and the heat conduction promotion layer 13 may be arranged on the lower surface of phase transition layer V. For example, a heat conduction structure including the heat conduction layer 12 and the heat conduction promotion layer 13 may be arranged on the upper surface of the phase transition layer V.

### Configuration Example 1-3

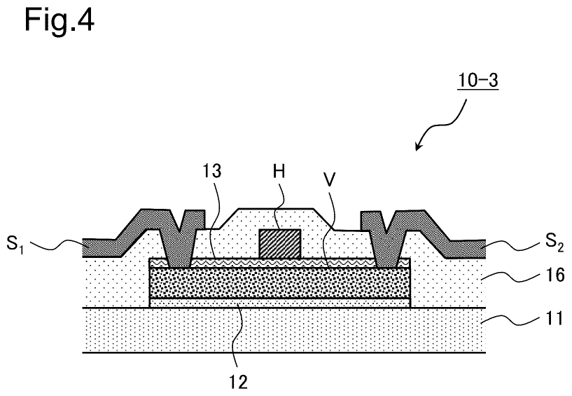

FIG. 4 is a conceptual diagram illustrating an example of the configuration (Configuration Example 1-3) of the switching element in the present disclosure. FIG. 4 is a cross-sectional view of the switching element cut along the cutting line A-A in FIG. 1. In the present configuration example, the heat conduction promotion layer is arranged at a position different from that of Configuration Example 1-2. Hereinafter, description of a configuration similar to that of Configuration Examples 1-1 and 1-2 will be omitted.

A switching element 10-3 includes the substrate 11, the heat conduction layer 12, the heat conduction promotion layer 13, the phase transition layer V, the heat generation element H, and the insulation layer 16. The substrate 11, the heat conduction layer 12, the heat conduction promotion layer 13, the phase transition layer V, and the heat generation element H are covered with the insulation layer 16. The phase transition layer V is electrically connected to the first signal line S₁ and the second signal line S₂. For example, the first signal line S₁ and the second signal line S₂ include metal such as copper or aluminum.

The heat conduction layer 12 is arranged on the upper surface of the substrate 11. The phase transition layer V is arranged on the upper surface of the heat conduction layer 12. The heat conduction layer 12 includes the material having the higher thermal conductivity than those of the substrate 11 and the phase transition layer V. That is, the heat conduction layer 12 has the higher thermal conductivity than those of the substrate 11 and the phase transition layer V.

The phase transition layer V is arranged on the upper surface of the heat conduction layer 12. The heat conduction promotion layer 13 is arranged on the upper surface of the phase transition layer V. The heat generation element H is arranged above the phase transition layer V via the heat conduction promotion layer 13. The phase transition layer V undergoes the phase transition from the insulation phase to the metal phase by heat generation of the heat generation element H. The phase transition layer V is electrically connected to the first signal line S₁ and the second signal line S₂ via the connection ends C. The phase transition layer V is arranged between the first signal line S₁ and the second signal line S₂ and functions as a switch.

The heat conduction promotion layer 13 is arranged on the upper surface of the phase transition layer V. The upper surface of the heat conduction promotion layer 13 is covered with the insulation layer 16. Through holes reaching the phase transition layer V are formed in a part of the heat conduction promotion layer 13. The connection ends C of the first signal line S₁ and the second signal line S₂ are arranged in the through holes formed in the heat conduction promotion layer 13. The heat conduction promotion layer 13 includes the material having the higher thermal conductivity than those of the phase transition layer V and the heat conduction layer 12. That is, the heat conduction promotion layer 13 has the higher thermal conductivity than those of the phase transition layer V and the heat conduction layer 12.

When the heat generation element H generates heat according to the selection via the TFT circuit, the heat is conducted to the heat conduction promotion layer 13 arranged on the upper surface of the phase transition layer V. The heat conducted to the heat conduction promotion layer 13 is conducted inside the heat conduction promotion layer 13, and is conducted to the phase transition layer V on a lower surface of the heat conduction promotion layer 13. Since the heat conduction promotion layer 13 has the higher thermal conductivity than that of the phase transition layer V, the heat is more efficiently conducted than in the phase transition layer V. The heat is conducted to the vanadium dioxide included in the phase transition layer V via the heat conduction promotion layer 13. The heat conducted to the phase transition layer V is conducted to the heat conduction layer 12 arranged on the lower surface of the phase transition layer V. Since the heat conduction layer 12 has the higher thermal conductivity than that of the phase transition layer V, the heat is more efficiently conducted than in the phase transition layer V. The heat conducted in the heat conduction layer 12 is conducted to the phase transition layer V arranged on the upper surface. As a result, the phase transition layer V is uniformly heated via the heat conduction promotion layer 13 arranged on the upper surface and the heat conduction layer 12 arranged on the lower surface. The heat conducted to the phase transition layer V is also conducted to the first signal line S₁ and the second signal line S₂ via the connection ends C. When the temperature of the vanadium dioxide exceeds the phase transition temperature, the vanadium dioxide undergoes the phase transition from the insulation phase to the metal phase. When the vanadium dioxide undergoes the phase transition to the metal phase, the switching element 10-3 transitions to an on state. When the heat generation of the deselected heat generation element H stops and the temperature of the vanadium dioxide falls below the phase transition temperature, the vanadium dioxide undergoes the phase transition from the metal phase to the insulation phase. When the vanadium dioxide undergoes the phase transition to the insulation phase, the switching element 10-3 transitions to an off state.

In the present configuration example, the phase transition layer V is sandwiched between the heat conduction layer 12 and the heat conduction promotion layer 13. In the present configuration example, heat is conducted to the phase transition layer V via the heat conduction layer 12 and the heat conduction promotion layer 13 having the higher thermal conductivities than that of the phase transition layer V. In the present configuration example, since the phase transition layer V is sandwiched between the heat conduction layer 12 and the heat conduction promotion layer 13 having the higher thermal conductivities than that of the phase transition layer V, the heat hardly escapes to the substrate 11, and the phase transition layer V can be heated more efficiently than in Configuration Examples 1-1 and 1-2. In the present configuration example, since the heat hardly escapes to the substrate 11, the size of the heat generation element H can be made smaller than in Configuration Examples 1-1 and 1-2. Therefore, according to the present configuration example, high-frequency coupling between the first signal line S₁ and the second signal line S₂ and the heat generation element H is less likely to occur than in Configuration Examples 1-1 and 1-2.

In the present configuration example, an example has been described in which the heat conduction promotion layer 13 is arranged on the upper surface of the phase transition layer V and the heat conduction layer 12 is arranged on the lower surface of the phase transition layer V. For example, the heat conduction layer 12 may be arranged on the upper surface of the phase transition layer V, and the heat conduction promotion layer 13 may be arranged on the lower surface of the phase transition layer V. For example, the heat conduction layer 12 may be arranged on both the surfaces of the phase transition layer V. For example, the heat conduction promotion layer 13 may be arranged on both the surfaces of the phase transition layer V. For example, the heat conduction layer 12 and the heat conduction promotion layer 13 may be arranged on an upper surface of the heat generation element H.

As described above, the switching element of the present example embodiment includes the substrate, the phase transition layer, the heat conduction layer, and the heat generation element. The substrate is the insulator having the lower thermal conductivity than those of the phase transition layer and the heat conduction layer. The phase transition layer includes the substance that undergoes the metal-insulator phase transition. For example, the phase transition layer includes the vanadium dioxide as the substance that undergoes the metal-insulator phase transition. The phase transition layer is arranged in the signal lines through which the signals to be transmitted and received propagate. The heat conduction layer is the insulator having the higher thermal conductivity than that of the phase transition layer. The heat conduction layer is formed between the substrate and the phase transition layer. The heat generation element has the rectangular shape having a long side along the direction perpendicular to the extension direction of the signal lines and a short side shorter than a side length of the phase transition layer. The heat generation element is thermally connected to the phase transition layer and the heat conduction layer. The heat generation element is arranged above the phase transition layer.

The switching element of the present example embodiment includes the phase transition layer including the substance that undergoes the metal-insulator phase transition. The heat conduction layer having the higher thermal conductivity than that of the phase transition layer is formed on the surface of the phase transition layer. The phase transition layer and the heat conduction layer are thermally connected to the heat generation element. When the heat generation element generates heat, the phase transition layer is uniformly heated via the heat conduction layer formed on the surface. Therefore, according to the configuration of the present example embodiment, even when the size of the heat generation element is reduced, the phase transition layer including the substance that undergoes the metal-insulator phase transition can be efficiently subjected to the phase transition. According to the configuration of the present example embodiment, by forming the heat generation element in the elongated rectangular shape, high-frequency coupling between the signal lines and the heat generation element hardly occurs.

In an aspect of the present example embodiment, the phase transition layer is arranged between the heat generation element and the heat conduction layer. In the present aspect, heat conducted to the heat conduction layer via the phase transition layer is conducted in the heat conduction layer faster than in the phase transition layer. Since the heat conducted in the heat conduction layer returns to the phase transition layer, the phase transition layer is easily uniformly heated. Therefore, according to the present example embodiment, the phase transition layer can be efficiently subjected to the phase transition.

The switching element according to an aspect of the present example embodiment includes the heat conduction promotion layer. The heat conduction promotion layer is the insulator having the higher thermal conductivity than that of the heat conduction layer, and is thermally connected to the phase transition layer. For example, the heat conduction promotion layer is arranged between the substrate and the heat conduction layer. For example, the heat conduction promotion layer is arranged between the phase transition element and the heat generation element. According to the present aspect, the phase transition layer can be more efficiently subjected to the phase transition by the heat conduction promotion layer having the higher thermal conductivity than that of the heat conduction layer.

### Second Example Embodiment

Next, a switching element in a second example embodiment will be described with reference to the drawings. The switching element of the present example embodiment is different from the switching element of the first example embodiment in a positional relationship between a phase transition layer and a heat generation element. Hereinafter, description of a configuration similar to that of the first example embodiment will be simplified or omitted.

### (Configuration)

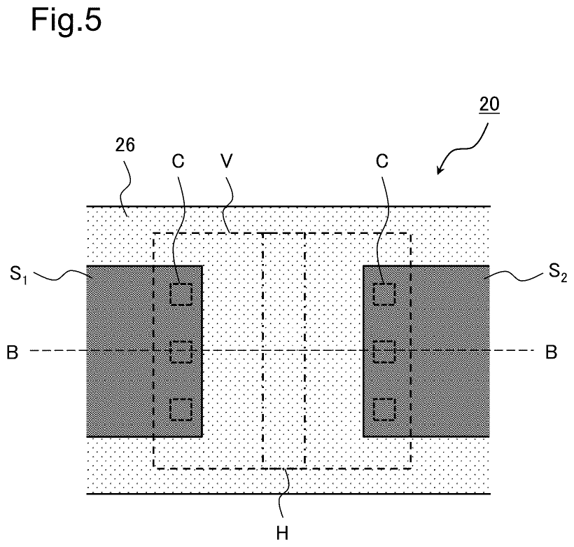

FIG. 5 is a conceptual diagram illustrating an example of a configuration of the switching element in the present disclosure. FIG. 5 is a plan view of the switching element viewed from an upper viewpoint. A switching element 20 includes a phase transition layer V and a heat generation element H. When viewed from the upper viewpoint, the phase transition layer V and the heat generation element H are arranged below an insulation layer 26. A formation region of the phase transition layer V is indicated by a broken line. A formation region of the heat generation element His indicated by an alternate long and short dash line. The heat generation element H is arranged below the phase transition layer V. A heat conduction layer (described later) is arranged on a lower surface of the phase transition layer V. The heat generation element His arranged below the phase transition layer V via the heat conduction layer. The phase transition layer V is electrically connected to a first signal line S₁ and a second signal line S₂ via connection ends C.

The phase transition layer V has a similar configuration to that of the phase transition layer V of the first example embodiment. The phase transition layer V includes a vanadium dioxide that undergoes a phase transition from an insulation phase to a metal phase at a phase transition temperature. The vanadium dioxide is the insulation phase at a temperature lower than the phase transition temperature. Therefore, at the temperature lower than the phase transition temperature, the switching element 20 is in an off state. The vanadium dioxide is the metal phase at a temperature higher than the phase transition temperature. Therefore, at the temperature higher than the phase transition temperature, the switching element 20 is in an on state. A resistance change in the phase transition of the insulation phase-metal phase of the vanadium dioxide indicates hysteresis characteristics. Therefore, in consideration of the hysteresis characteristics, the temperature of the phase transition layer V is adjusted in such a way as to cross the phase transition temperature.

In the present example embodiment, two configuration examples will be described regarding the switching element 20. Hereinafter, the configuration examples of the switching element 20 are distinguished by adding a hyphen (-) and a number after a reference sign (20).

### Configuration Example 2-1

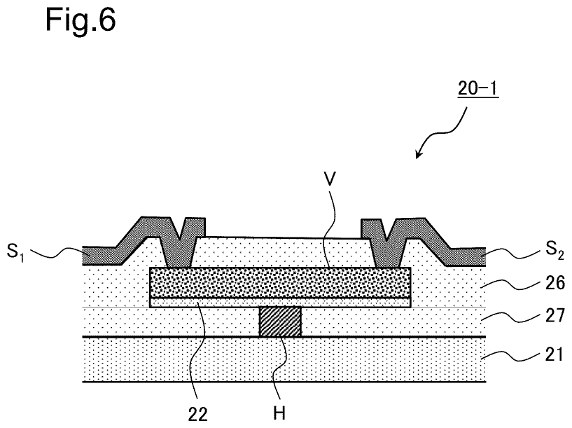

FIG. 6 is a conceptual diagram illustrating an example of the configuration (Configuration Example 2-1) of the switching element in the present disclosure. FIG. 6 is a cross-sectional view of the switching element cut along a cutting line B-B in FIG. 5.

A switching element 20-1 includes a substrate 21, a heat conduction layer 22, the phase transition layer V, the heat generation element H, the insulation layer 26, and an insulation layer 27. The insulation layer 27 is formed on an upper surface of the substrate 21. A through hole is formed in the insulation layer 27. The heat generation element His embedded in the through hole of the insulation layer 27. The heat conduction layer 22 and the phase transition layer V are arranged above the insulation layer 27 and the heat generation element H. The heat conduction layer 22 and the phase transition layer V are covered with the insulation layer 26. The phase transition layer V is electrically connected to the first signal line S₁ and the second signal line S₂ via through holes formed in the insulation layer 26. For example, the first signal line S₁ and the second signal line S₂ include metal such as copper or aluminum.

The substrate 21 has a similar configuration to that of the substrate 11 of the first example embodiment. The substrate 21 is an insulator (dielectric). The substrate 21 has a thermal conductivity lower than that of the phase transition layer V.

The heat conduction layer 22 has a similar configuration to that of the heat conduction layer 12 of the first example embodiment. The heat conduction layer 22 is arranged on an upper surface of the insulation layer 27 in which the heat generation element His embedded. The phase transition layer V is arranged on an upper surface of the heat conduction layer 22. The heat conduction layer 22 includes a material having a higher thermal conductivity than those of the substrate 21, the insulation layer 27, and the phase transition layer V.

The phase transition layer V has the similar configuration to that of the phase transition layer V of the first example embodiment. The phase transition layer V is arranged on the upper surface of the heat conduction layer 22. To the phase transition layer V, heat generated from the heat generation element H is conducted via the heat conduction layer 22. The phase transition layer V undergoes the phase transition from the insulation phase to the metal phase by heat generation of the heat generation element H. The phase transition layer V is electrically connected to the first signal line S₁ and the second signal line S₂ via the connection ends C. The phase transition layer V is arranged between the first signal line S₁ and the second signal line S₂ and functions as a switch.

The heat generation element H has a similar configuration to that of the first example embodiment. The heat generation element His arranged on a lower surface of the heat conduction layer 22. The heat generation element H has an elongated rectangular shape along a direction perpendicular to an extension direction of the first signal line S₁ and the second signal line S₂. The heat generation element H is smaller than the phase transition layer V. A temperature of the heat generation element H is controlled according to selection via a TFT circuit (not illustrated). The heat generation element H is connected to a drive circuit constituting the TFT circuit by a temperature control line. A TFT wiring includes a plurality of selection lines and a plurality of data lines. When the drive circuit connected to the heat generation element H is selected, the heat generation element H generates heat. The heat of the heat generation element H is conducted to the phase transition layer V arranged above the heat generation element H via the heat conduction layer 22. The resistance change in the phase transition of the insulation phase-metal phase of the vanadium dioxide indicates the hysteresis characteristics. Therefore, in consideration of the hysteresis characteristics, the temperature of the heat generation element His controlled in such a way that the temperature of the phase transition layer V crosses the phase transition temperature.

The insulation layer 26 has a similar configuration to that of the insulation layer 16 of the first example embodiment. The insulation layer 26 covers the heat conduction layer 22 and the phase transition layer V. The insulation layer 26 opens above two opposing ends of the phase transition layer V. The connection ends C of the first signal line S₁ and the second signal line S₂ are electrically connected to the phase transition layer V via the openings formed in the insulation layer 26. A thermal conductivity of the insulation layer 26 is about the same as that of the substrate 21. That is, the insulation layer 26 has the lower thermal conductivity than that of the phase transition layer V.

The insulation layer 27 is formed on the upper surface of the substrate 21. The through hole for arranging the heat generation element H is formed in the insulation layer 27. The heat generation element His embedded in the through hole of the insulation layer 27. For example, the insulation layer 27 includes an insulation material such as silicon dioxide. When there are irregularities on the surface of the phase transition layer V formed on the upper layer of the insulation layer 27, these irregularities may serve as singular points and signal reflection may occur. Therefore, the upper surface of the insulation layer 27 is planarized. For example, the upper surface of the insulation layer 27 is planarized using a technique such as chemical mechanical polishing (CMP). The thermal conductivity of the insulation layer 27 is about the same as those of the substrate 21 and the insulation layer 26. That is, the insulation layer 27 has the lower thermal conductivity than that of the phase transition layer V.

When the heat generation element H generates heat according to the selection via the TFT circuit, the heat is conducted to the heat conduction layer 22 arranged on an upper surface of the heat generation element H. The heat conducted to the heat conduction layer 22 is conducted to the phase transition layer V arranged on the upper surface. Since the heat conduction layer 22 has the higher thermal conductivity than that of the phase transition layer V, the heat is more efficiently conducted than in the phase transition layer V. As a result, the phase transition layer V is uniformly heated via the heat conduction layer 22 arranged on the lower surface. The heat conducted to the phase transition layer V is also conducted to the first signal line S₁ and the second signal line S₂ via the connection ends C. When the temperature of the vanadium dioxide exceeds the phase transition temperature, the vanadium dioxide undergoes the phase transition from the insulation phase to the metal phase. When the vanadium dioxide undergoes the phase transition to the metal phase, the switching element 20-1 transitions to an on state. When the heat generation of the deselected heat generation element H stops and the temperature of the vanadium dioxide falls below the phase transition temperature, the vanadium dioxide undergoes a phase transition from the metal phase to the insulation phase. When the vanadium dioxide undergoes the phase transition to the insulation phase, the switching element 20-1 transitions to an off state.

In the present configuration example, heat is conducted to the phase transition layer V via the heat conduction layer 22 having the higher thermal conductivity than that of the phase transition layer V. In the present configuration example, since the heat generation element His in direct contact with the heat conduction layer 22, the heat of the heat generation element H is easily conducted to the heat conduction layer 22, and the heat hardly escapes to the substrate 21. Therefore, according to the present configuration example, the phase transition layer V can be efficiently heated as compared with the first example embodiment. In the present configuration example, the first signal line S₁ and the second signal line S₂ can be arranged at positions separated from the heat generation element H. Therefore, according to the present configuration example, high-frequency coupling between the first signal line S₁ and the second signal line S₂ and the heat generation element H is less likely to occur than in the first example embodiment.

### Configuration Example 2-2

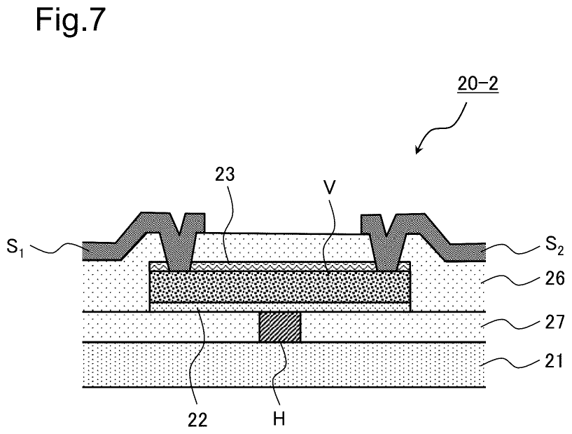

FIG. 7 is a conceptual diagram illustrating an example of the configuration (Configuration Example 2-2) of the switching element in the present disclosure. FIG. 7 is a cross-sectional view of the switching element cut along the cutting line B-B in FIG. 5. The present configuration example is different from Configuration Example 2-1 in that a heat conduction promotion layer 23 is arranged on an upper surface of phase transition layer V. Hereinafter, description of a configuration similar to that of Configuration Example 2-1 will be omitted.

A switching element 20-2 includes the substrate 21, the heat conduction layer 22, the heat conduction promotion layer 23, the phase transition layer V, the heat generation element H, the insulation layer 26, and the insulation layer 27. The insulation layer 27 is formed on the upper surface of the substrate 21. The through hole is formed in the insulation layer 27. The heat generation element His embedded in the through hole formed in the insulation layer 27. The heat conduction layer 22, the heat conduction promotion layer 23, and the phase transition layer V are arranged above the insulation layer 27. The heat conduction layer 22, the heat conduction promotion layer 23, and the phase transition layer V are covered with the insulation layer 26. The phase transition layer V is electrically connected to the first signal line S₁ and the second signal line S₂ via the openings formed in the insulation layer 26. For example, the first signal line S₁ and the second signal line S₂ include metal such as copper or aluminum.

The heat conduction layer 22 is arranged on the upper surface of the insulation layer 27 in which the heat generation element His embedded. The phase transition layer V is arranged on the upper surface of the heat conduction layer 22. The heat conduction layer 22 includes the material having the higher thermal conductivity than those of the substrate 21, the insulation layer 27, and the phase transition layer V.

The phase transition layer V is arranged on the upper surface of the heat conduction layer 22. The heat conduction promotion layer 23 is arranged on the upper surface of the phase transition layer V. The heat generation element His arranged below the phase transition layer V via the heat conduction layer 22. The phase transition layer V undergoes the phase transition from the insulation phase to the metal phase by heat generation of the heat generation element H. The phase transition layer V is electrically connected to the first signal line S₁ and the second signal line S₂ via the connection ends C. The phase transition layer V is arranged between the first signal line S₁ and the second signal line S₂ and functions as a switch.

The heat conduction promotion layer 23 has a similar configuration to that of the heat conduction promotion layer 13 of the first example embodiment. The heat conduction promotion layer 23 is arranged on the upper surface of the phase transition layer V. The upper surface of the heat conduction promotion layer 23 is covered with the insulation layer 26. The heat conduction promotion layer 23 includes a material having a higher thermal conductivity than those of the phase transition layer V and the heat conduction layer 22. That is, the heat conduction promotion layer 23 has the higher thermal conductivity than those of the phase transition layer V and the heat conduction layer 22.

When the heat generation element H generates heat according to the selection via the TFT circuit, the heat is conducted to the heat conduction layer 22 arranged on the lower surface of the phase transition layer V. The heat conducted to the heat conduction layer 22 is conducted inside the heat conduction layer 22, and is conducted to the phase transition layer V on the upper surface of the heat conduction layer 22. Since the heat conduction layer 22 has the higher thermal conductivity than that of the phase transition layer V, the heat is more efficiently conducted than in the phase transition layer V. The heat of the heat generation element H is conducted to the vanadium dioxide included in the phase transition layer V via the heat conduction layer 22. The heat conducted to the upper surface of the phase transition layer V is conducted to the heat conduction promotion layer 23. Since the heat conduction promotion layer 23 has the higher thermal conductivity than that of the phase transition layer V, the heat is more efficiently conducted than in the phase transition layer V. The heat conducted in the heat conduction promotion layer 23 is conducted to the phase transition layer V arranged on the lower surface. As a result, the phase transition layer V is uniformly heated via the heat conduction promotion layer 23 arranged on the upper surface and the heat conduction layer 22 arranged on the lower surface. The heat conducted to the phase transition layer V is also conducted to the first signal line S₁ and the second signal line S₂ via the connection ends C. When the temperature of the vanadium dioxide exceeds the phase transition temperature, the vanadium dioxide undergoes the phase transition from the insulation phase to the metal phase. When the vanadium dioxide undergoes the phase transition to the metal phase, the switching element 20-2 transitions to an on state. When the heat generation of the deselected heat generation element H stops and the temperature of the vanadium dioxide falls below the phase transition temperature, the vanadium dioxide undergoes the phase transition from the metal phase to the insulation phase. When the vanadium dioxide undergoes the phase transition to the insulation phase, the switching element 20-2 transitions to an off state.

In the present configuration example, the phase transition layer V is sandwiched between the heat conduction layer 22 and the heat conduction promotion layer 23. In the present configuration example, heat is conducted to the phase transition layer V via the heat conduction layer 22 and the heat conduction promotion layer 23 having the higher thermal conductivities than that of the phase transition layer V. In the present configuration example, since the phase transition layer V is sandwiched between the heat conduction layer 22 and the heat conduction promotion layer 23 having the higher thermal conductivities than that of the phase transition layer V, the heat hardly escapes to the substrate 21, and the phase transition layer V can be heated more efficiently than in Configuration Example 2-1. In the present configuration example, since the heat hardly escapes to the substrate 21, a size of the heat generation element H can be made smaller than in Configuration Example 2-1. Therefore, according to the present configuration example, high-frequency coupling between the first signal line S₁ and the second signal line S₂ and the heat generation element H is less likely to occur than in Configuration Example 2-1.

In the present configuration example, an example has been described in which the heat conduction promotion layer 23 is arranged on the upper surface of the phase transition layer V and the heat conduction layer 22 is arranged on the lower surface of the phase transition layer V. For example, the heat conduction layer 22 may be arranged on the upper surface of the phase transition layer V, and the heat conduction promotion layer 23 may be arranged on the lower surface of the phase transition layer V. For example, the heat conduction layer 22 may be arranged on both the surfaces of the phase transition layer V. For example, the heat conduction promotion layer 23 may be arranged on both the surfaces of the phase transition layer V. For example, a heat conduction structure including the heat conduction layer 22 and the heat conduction promotion layer 23 may be arranged on the upper surface or the lower surface of the phase transition layer V.

As described above, the switching element of the present example embodiment includes the substrate, the phase transition layer, the heat conduction layer, and the heat generation element. The substrate is the insulator having the lower thermal conductivity than those of the phase transition layer and the heat conduction layer. The phase transition layer includes the substance that undergoes the metal-insulator phase transition. For example, the phase transition layer includes the vanadium dioxide as the substance that undergoes the metal-insulator phase transition. The phase transition layer is arranged in the signal lines through which the signals to be transmitted and received propagate. The heat conduction layer is the insulator having the higher thermal conductivity than that of the phase transition layer. The heat conduction layer is formed between the substrate and the phase transition layer. The heat generation element has the rectangular shape having a long side along the direction perpendicular to the extension direction of the signal lines and a short side shorter than a side length of the phase transition layer. The heat generation element is thermally connected to the phase transition layer and the heat conduction layer. The heat generation element is arranged below the phase transition layer. For example, the heat generation element is embedded in the insulation layer.

The switching element of the present example embodiment includes the phase transition layer including the substance that undergoes the metal-insulator phase transition. The heat conduction layer having the higher thermal conductivity than that of the phase transition layer is formed on the surface of the phase transition layer. The phase transition layer and the heat conduction layer are thermally connected to the heat generation element. When the heat generation element generates heat, the phase transition layer is uniformly heated via the heat conduction layer formed on the surface. Therefore, according to the configuration of the present example embodiment, even when the size of the heat generation element is reduced, the phase transition layer including the substance that undergoes the metal-insulator phase transition can be efficiently subjected to the phase transition. According to the configuration of the present example embodiment, since the signal lines and the heat generation element are arranged separately, high-frequency coupling between the signal lines and the heat generation element hardly occurs.

In an aspect of the present example embodiment, the heat conduction layer is arranged between the phase transition layer and the heat generation element. In the present aspect, heat conducted to the heat conduction layer via the phase transition layer is conducted in the heat conduction layer faster than in the phase transition layer. Since the heat conducted in the heat conduction layer returns to the phase transition layer, the phase transition layer is easily uniformly heated. Therefore, according to the present example embodiment, the phase transition layer can be efficiently subjected to the phase transition.

The switching element according to an aspect of the present example embodiment includes the heat conduction promotion layer. The heat conduction promotion layer is the insulator having the higher thermal conductivity than that of the heat conduction layer, and is thermally connected to the phase transition layer. For example, the heat conduction promotion layer is arranged on the upper surface of the phase transition element. For example, the heat conduction promotion layer is arranged between the heat conduction layer and the heat generation element. According to the present aspect, the phase transition layer can be more efficiently subjected to the phase transition by the heat conduction promotion layer having the higher thermal conductivity than that of the heat conduction layer.

### Third Example Embodiment

Next, a switching element in a third example embodiment will be described with reference to the drawings. The switching element of the present example embodiment is different from the switching elements of the first example embodiment and the second example embodiment in a connection structure between a phase transition layer and a signal line. Hereinafter, description of a configuration similar to that of the first example embodiment or the second example embodiment will be simplified or omitted.

### (Configuration)

In the switching element of the present example embodiment, when a vanadium dioxide included in the phase transition layer is formed, metal vanadium is left at a connection portion with a first signal line and a second signal line. That is, the first signal line and the second signal line are electrically connected to the phase transition layer via the metal vanadium. In the present example embodiment, two configuration examples will be described regarding the switching element. Hereinafter, the configuration examples of the switching element are distinguished by adding a hyphen (-) and a number after the reference sign.

### Configuration Example 3-1

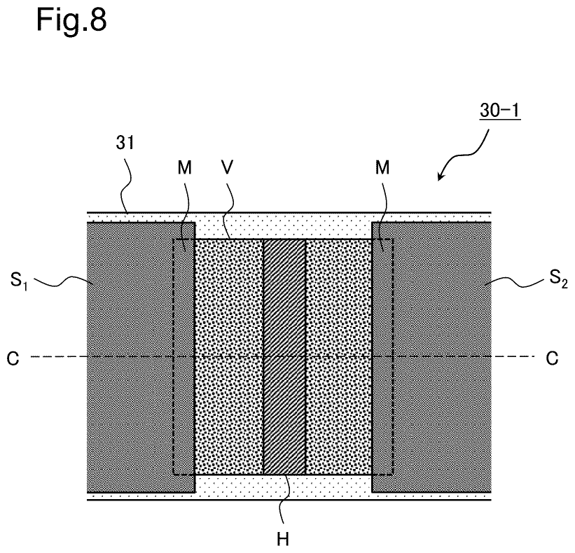

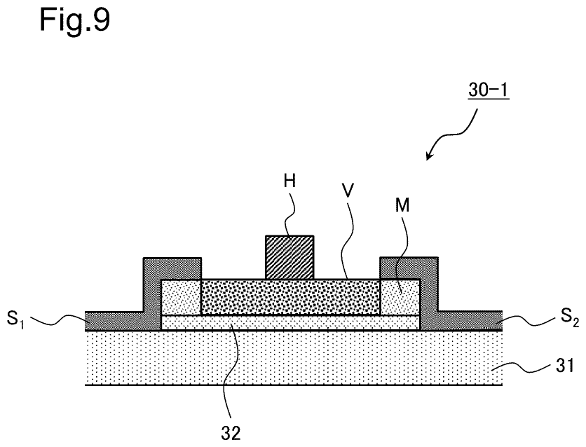

FIGS. 8 and 9 are conceptual diagrams illustrating an example of a configuration (Configuration Example 3-1) of the switching element in the present disclosure. Configuration Example 3-1 is an example in which a heat generation element is arranged above the phase transition layer. A heat conduction layer or a heat conduction promotion layer may be arranged between the phase transition layer and the heat generation element. FIG. 8 is a plan view of the switching element viewed from an upper viewpoint. FIG. 9 is a cross-sectional view of the switching element cut along a cutting line C-C in FIG. 8.

A switching element 30-1 includes a substrate 31, a heat conduction layer 32, a phase transition layer V, metal layers M, and a heat generation element H. The phase transition layer V is arranged above the substrate 31. The heat conduction layer 32 is arranged on a lower surface of the phase transition layer V. The metal layers M are formed at left and right ends of the phase transition layer V. The metal layer M on the left side of the phase transition layer V is covered with a first signal line S₁. The metal layer M on the right side of the phase transition layer V is covered with a second signal line S₂. The phase transition layer V is electrically connected to the first signal line S₁ and the second signal line S₂ via the metal layers M. The heat generation element His arranged on an upper surface of the phase transition layer V. For example, the first signal line S₁ and the second signal line S₂ include metal such as copper or aluminum.

The substrate 31 has a similar configuration to that of the substrate 11 of the first example embodiment. The substrate 31 is an insulator (dielectric). The substrate 31 has a thermal conductivity lower than that of the phase transition layer V. An insulation layer (not illustrated) may be formed on an upper surface of the substrate 31.

The heat conduction layer 32 has a similar configuration to that of the heat conduction layer 12 of the first example embodiment. The heat conduction layer 32 is arranged on the upper surface of the substrate 31. The phase transition layer V and the metal layers M are formed on the upper surface of the heat conduction layer 32. The heat conduction layer 32 includes a material having a higher thermal conductivity than those of the substrate 31 and the phase transition layer V.

The phase transition layer V has a similar configuration to that of the phase transition layer V of the first example embodiment. The phase transition layer V is different from the phase transition layer V of the first example embodiment in that the phase transition layer V is electrically connected to the first signal line S₁ and the second signal line S₂ via the metal layers M. The phase transition layer V includes a vanadium dioxide that undergoes a phase transition from an insulation phase to a metal phase at a phase transition temperature. The phase transition layer V is arranged on an upper surface of the heat conduction layer 32. To the phase transition layer V, heat of the heat generation element His conducted via the heat conduction layer 32. The phase transition layer V undergoes the phase transition from the insulation phase to the metal phase by heat generation of the heat generation element H.

The phase transition layer V is electrically connected to the first signal line S₁ and the second signal line S₂ via the metal layers M. The phase transition layer V is arranged between the first signal line S₁ and the second signal line S₂ and functions as a switch. The vanadium dioxide is the insulation phase at a temperature lower than the phase transition temperature. Therefore, at the temperature lower than the phase transition temperature, the switching element 30-1 is in an off state. The vanadium dioxide is the metal phase at a temperature higher than the phase transition temperature. Therefore, at the temperature higher than the phase transition temperature, the switching element 30-1 is in an on state. A resistance change in the phase transition of the insulation phase-metal phase of the vanadium dioxide indicates hysteresis characteristics. Therefore, in consideration of the hysteresis characteristics, the temperature of the phase transition layer V is adjusted in such a way as to cross the phase transition temperature.

The metal layers M are formed at the ends of the phase transition layer V. The metal layers M are formed on the upper surface of the heat conduction layer 32. The metal layers M are formed between the first signal line S₁ and the heat conduction layer 32 and between the second signal line S₂ and the heat conduction layer 32. The metal layers M are electrically connected to the first signal line S₁ and the second signal line S₂. To the metal layers M, heat of the heat generation element His conducted via the heat conduction layer 32 and the phase transition layer V.

Here, a method of forming the phase transition layer V and the metal layers M will be described. First, the heat conduction layer 32 is formed on the upper surface of the substrate 31. For example, the heat conduction layer 32 is a thin film layer of α-alumina. After the heat conduction layer 32 is formed on the upper surface of the substrate 31, the metal vanadium is laminated on the upper surface of the heat conduction layer 32. For example, the metal vanadium is laminated on the upper surface of the heat conduction layer 32 using a technique such as a sputtering method. Thereafter, the heat conduction layer 32 and the metal vanadium are patterned in the same shape. Upper portions of ends of the metal vanadium, and side surfaces of the heat conduction layer 32 and the metal vanadium are covered with metal electrodes (the first signal line S₁ and the second signal line S₂). Thereafter, annealing is performed in an oxidizing atmosphere. According to such a procedure, a portion of the metal vanadium not covered with the metal electrodes (the first signal line S₁ and the second signal line S₂) is oxidized to become the vanadium dioxide (the phase transition layer V). On the other hand, the portions covered with the metal electrodes (the first signal line S₁ and the second signal line S₂) are left as the metal layers M. As a result, the phase transition layer V and the metal layers M are seamlessly connected. The method of forming the phase transition layer V and the metal layers M described here is an example, and the method of forming the phase transition layer V and the metal layers M in the present example embodiment is not limited. For example, the phase transition layer V may be formed by implanting oxygen ions into the metal vanadium using an ion implantation technique.

The heat generation element H has a similar configuration to that of the heat generation element H of the first example embodiment. The heat generation element H is arranged on an upper surface of the phase transition layer V. The heat generation element H has an elongated rectangular shape along a direction perpendicular to an extension direction of the first signal line S₁ and the second signal line S₂. That is, the heat generation element H is smaller than the phase transition layer V. A temperature of the heat generation element H is controlled according to selection via a TFT circuit (not illustrated). The heat generation element H is connected to a drive circuit constituting the TFT circuit by a temperature control line. A TFT wiring includes a plurality of selection lines and a plurality of data lines. When the drive circuit connected to the heat generation element H is selected, the heat generation element H generates heat. The heat of the heat generation element H is conducted to the phase transition layer V arranged on a lower surface of the heat generation element H. The resistance change in the phase transition of the insulation phase-metal phase of the vanadium dioxide indicates the hysteresis characteristics. Therefore, in consideration of the hysteresis characteristics, the temperature of the heat generation element H is controlled in such a way that the temperature of the phase transition layer V crosses the phase transition temperature.

When the heat generation element H generates heat according to the selection via the TFT circuit, the heat is conducted to the phase transition layer V. The heat conducted to the phase transition layer V is conducted to the heat conduction layer 32 arranged on the lower surface of the phase transition layer V. Since the heat conduction layer 32 has the higher thermal conductivity than that of the phase transition layer V, the heat is more efficiently conducted than in the phase transition layer V. The heat conducted in the heat conduction layer 32 is conducted to the phase transition layer V arranged on the upper surface. As a result, the phase transition layer V is uniformly heated via the heat conduction layer 32 arranged on the lower surface. When the temperature of the vanadium dioxide exceeds the phase transition temperature, the vanadium dioxide undergoes the phase transition from the insulation phase to the metal phase. When the vanadium dioxide undergoes the phase transition to the metal phase, the switching element 30-1 transitions to the on state. The heat conducted to the phase transition layer V is also conducted to the first signal line S₁ and the second signal line S₂ via the metal layers M. When the heat generation of the deselected heat generation element H stops and the temperature of the vanadium dioxide falls below the phase transition temperature, the vanadium dioxide undergoes a phase transition from the metal phase to the insulation phase. When the vanadium dioxide undergoes the phase transition to the insulation phase, the switching element 30-1 transitions to the off state.

The metal vanadium constituting the metal layers M has a thermal conductivity lower than that of the metal constituting the first signal line S₁ and the second signal line S₂. Therefore, as compared with the first and second example embodiments, the heat conducted in the heat conduction layer 32 is less likely to be conducted to the signal lines (the first signal line S₁ and the second signal line S₂) in the present configuration example. Since the metal layers M and the phase transition layer V are configured without a discontinuous portion, electricity is efficiently conducted when the phase transition layer V undergoes the phase transition to the metal phase. The metal vanadium has a lower electrical conductivity than those of copper and aluminum, but has the higher electrical conductivity than that of the vanadium dioxide. Therefore, as compared with the first and second example embodiments, a resistance between the first signal line S₁ and the second signal line S₂ and the phase transition layer V via the metal layers Mis smaller in the present configuration example. In the present configuration example, an area of a contact portion between the metal layers M and the phase transition layer V is very small as compared with an area of a contact portion between the phase transition layer V and the signal layer in the first and second example embodiments. Therefore, in the present configuration example, since a temperature rise of the metal layers M can be suppressed, a contact resistance at the contact portion between the metal layers M and the phase transition layer V can be reduced.

### Configuration Example 3-2

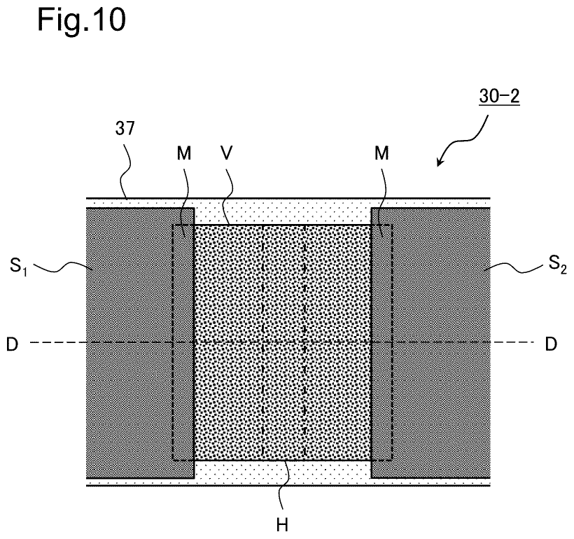

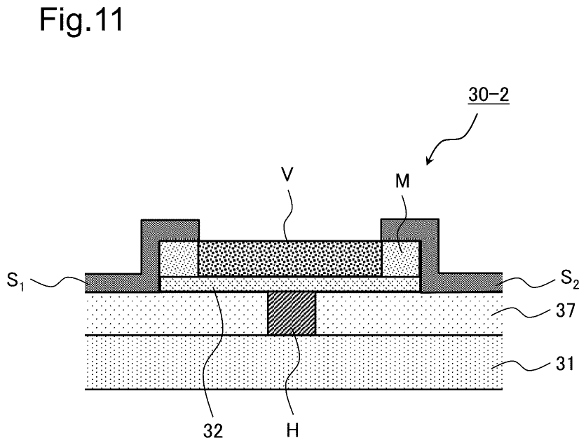

FIGS. 10 and 11 are conceptual diagrams illustrating an example of the configuration (Configuration Example 3-2) of the switching element in the present disclosure. Configuration Example 3-2 is an example in which the heat generation element is arranged below the phase transition layer. FIG. 10 is a plan view of the switching element viewed from the upper viewpoint. FIG. 11 is a cross-sectional view of the switching element cut along a cutting line D-D in FIG. 10. Hereinafter, description of a configuration similar to that of Configuration Example 3-1 will be omitted.

A switching element 30-2 includes the substrate 31, the heat conduction layer 32, the phase transition layer V, the metal layers M, the heat generation element H, and an insulation layer 37. The phase transition layer V is arranged on above the insulation layer 37. The heat conduction layer 32 is arranged on the lower surface of the phase transition layer V. The end on the left side of the phase transition layer V is covered with the first signal line S₁. The end on the right side of the phase transition layer V is covered with the second signal line S₂. The phase transition layer V is electrically connected to the first signal line S₁ and the second signal line S₂ via the metal layers M. A formation region of the phase transition layer V covered with the first signal line S₁ and the second signal line S₂ are indicated by a broken line. The portions covered with the first signal line S₁ and the second signal line S₂ are the metal layers M. The heat generation element H is arranged below the phase transition layer V. The heat generation element His arranged on a lower surface of the heat conduction layer 32. A formation region of the heat generation element H is indicated by an alternate long and short dash line. For example, the first signal line S₁ and the second signal line S₂ include metal such as copper or aluminum.

The substrate 31 has the similar configuration to that of the substrate 11 of the first example embodiment. The substrate 31 is the insulator (dielectric). The substrate 31 has the thermal conductivity lower than that of the phase transition layer V. The insulation layer (not illustrated) may be formed on the upper surface of the substrate 31.

The heat conduction layer 32 has the similar configuration to that of the heat conduction layer 12 of the first example embodiment. The heat conduction layer 32 is arranged on the upper surface of the substrate 31. The phase transition layer V and the metal layers M are arranged on the upper surface of the heat conduction layer 32. The heat conduction layer 32 includes the material having the higher thermal conductivity than those of the substrate 31 and the phase transition layer V.

The phase transition layer V has the similar configuration to that of the phase transition layer V of the first example embodiment. The phase transition layer V is different from the phase transition layer V of the second example embodiment in that the phase transition layer V is electrically connected to the first signal line S₁ and the second signal line S₂ via the metal layers M. The phase transition layer V includes the vanadium dioxide that undergoes the phase transition from the insulation phase to the metal phase at the phase transition temperature. The phase transition layer V is arranged on the upper surface of the heat conduction layer 32. To the phase transition layer V, heat of the heat generation element His conducted via the heat conduction layer 32. The phase transition layer V undergoes the phase transition from the insulation phase to the metal phase by heat generation of the heat generation element H.

The phase transition layer V is electrically connected to the first signal line S₁ and the second signal line S₂ via the metal layers M. The phase transition layer V is arranged between the first signal line S₁ and the second signal line S₂ and functions as a switch. The vanadium dioxide is the insulation phase at the temperature lower than the phase transition temperature. Therefore, at the temperature lower than the phase transition temperature, the switching element 30-2 is in an off state. The vanadium dioxide is the metal phase at the temperature higher than the phase transition temperature. Therefore, at the temperature higher than the phase transition temperature, the switching element 30-2 is in an on state. The resistance change in the phase transition of the insulation phase-metal phase of the vanadium dioxide indicates the hysteresis characteristics. Therefore, in consideration of the hysteresis characteristics, the temperature of the phase transition layer V is adjusted in such a way as to cross the phase transition temperature.

The metal layers M are connected to the ends of the phase transition layer V. The metal layers M are arranged on the upper surface of the heat conduction layer 32. The metal layers M are formed between the first signal line S₁ and the heat conduction layer 32 and between the second signal line S₂ and the heat conduction layer 32. The metal layers M are electrically connected to the first signal line S₁ and the second signal line S₂. To the metal layers M, heat of the heat generation element His conducted via the heat conduction layer 32 and the phase transition layer V. The metal layers M can be formed in a manner similar to that in Configuration Example 3-1.

The heat generation element H has a similar configuration to that of the heat generation element H of the first example embodiment. The heat generation element H is arranged on the lower surface of the heat conduction layer 32. The heat generation element H has the elongated rectangular shape along the direction perpendicular to the extension direction of the first signal line S₁ and the second signal line S₂. That is, the heat generation element H is smaller than the phase transition layer V. The temperature of the heat generation element H is controlled according to the selection via the TFT circuit (not illustrated). The heat generation element H is connected to the drive circuit constituting the TFT circuit by the temperature control line. The TFT wiring includes the plurality of selection lines and the plurality of data lines. When the drive circuit connected to the heat generation element H is selected, the heat generation element H generates heat. The heat of the heat generation element His conducted to the heat conduction layer 32 arranged on an upper surface of the heat generation element H. The heat conducted to the heat conduction layer 32 is conducted inside the heat conduction layer 32, and is conducted to the phase transition layer V arranged on the upper surface of the heat conduction layer 32. The resistance change in the phase transition of the insulation phase-metal phase of the vanadium dioxide indicates the hysteresis characteristics. Therefore, in consideration of the hysteresis characteristics, the temperature of the heat generation element H is controlled in such a way that the temperature of the phase transition layer V crosses the phase transition temperature.

The insulation layer 37 is formed on the upper surface of the substrate 31. The heat generation element His embedded in the insulation layer 37. For example, the insulation layer 37 includes an insulation material such as silicon dioxide. When there are irregularities on the surface of the phase transition layer V formed on the upper layer of the insulation layer 37, these irregularities may serve as singular points and signal reflection may occur. Therefore, the upper surface of the insulation layer 37 is planarized. For example, an upper surface of the insulation layer 37 is planarized using a technique such as chemical mechanical polishing (CMP). A thermal conductivity of the insulation layer 37 is about the same as that of the substrate 31. That is, the insulation layer 37 has the lower thermal conductivity than that of the phase transition layer V.

When the heat generation element H generates heat according to the selection via the TFT circuit, the heat is conducted to the heat conduction layer 32 arranged on the upper surface of the heat generation element H. The heat conducted to the heat conduction layer 32 is conducted to the phase transition layer V arranged on the upper surface. Since the heat conduction layer 32 has the higher thermal conductivity than that of the phase transition layer V, the heat is more efficiently conducted than in the phase transition layer V. As a result, the phase transition layer V is uniformly heated via the heat conduction layer 32 arranged on the lower surface. The heat conducted to the phase transition layer V is also conducted to the first signal line S₁ and the second signal line S₂ via the metal layers M. When the temperature of the vanadium dioxide exceeds the phase transition temperature, the vanadium dioxide undergoes the phase transition from the insulation phase to the metal phase. When the vanadium dioxide undergoes the phase transition to the metal phase, the switching element 30-2 transitions to the on state. When the heat generation of the deselected heat generation element H stops and the temperature of the vanadium dioxide falls below the phase transition temperature, the vanadium dioxide undergoes a phase transition from the metal phase to the insulation phase. When the vanadium dioxide undergoes the phase transition to the insulation phase, the switching element 30-2 transitions to the off state.

The metal vanadium constituting the metal layers M has the thermal conductivity lower than that of the metal constituting the first signal line S₁ and the second signal line S₂. Therefore, as compared with the second example embodiment, the heat conducted in the heat conduction layer 32 is less likely to be conducted to the first signal line S₁ and the second signal line S₂ in the present configuration example. Since the metal layers M and the phase transition layer V are configured without a discontinuous portion, electricity is efficiently conducted when the phase transition layer V undergoes the phase transition to the metal phase. The metal vanadium has the lower electrical conductivity than those of copper and aluminum, but has the higher electrical conductivity than that of the vanadium dioxide. Therefore, as compared with the first and second example embodiments, the resistance between the first signal line S₁ and the second signal line S₂ and the phase transition layer V via the metal layers M is smaller in the present configuration example. In the present configuration example, the area of the contact portion between the metal layers M and the phase transition layer V is very small as compared with the area of the contact portion between the phase transition layer V and the signal layer in the first and second example embodiments. Therefore, in the present configuration example, since the temperature rise of the metal layers M can be suppressed, the contact resistance at the contact portion between the metal layers M and the phase transition layer V can be reduced. According to the present configuration example, since the signal lines (the first signal line S₁ and the second signal line S₂) and the heat generation element H are arranged separately, high-frequency coupling between the signal lines and the heat generation element hardly occurs.

As described above, the switching element of the present example embodiment includes the substrate, the phase transition layer, the heat conduction layer, and the heat generation element. The substrate is the insulator having the lower thermal conductivity than those of the phase transition layer and the heat conduction layer. The phase transition layer includes the substance that undergoes the metal-insulator phase transition. For example, the phase transition layer includes the vanadium dioxide as the substance that undergoes the metal-insulator phase transition. The phase transition layer is arranged in the signal lines through which the signals to be transmitted and received propagate. The phase transition layer is connected to the signal lines via the metal vanadium. The heat conduction layer is the insulator having the higher thermal conductivity than that of the phase transition layer. The heat conduction layer is formed between the substrate and the phase transition layer. The heat generation element has the rectangular shape having a long side along the direction perpendicular to the extension direction of the signal lines and a short side shorter than a side length of the phase transition layer. The heat generation element is thermally connected to the phase transition layer and the heat conduction layer. The heat generation element is arranged above or below the phase transition layer.

In the switching element of the present example embodiment, the phase transition layer and the signal lines are in contact with each other via the metal vanadium. The metal vanadium has the lower thermal conductivity than that of the material constituting the signal line. Therefore, according to the present example embodiment, since the heat hardly escapes from the phase transition layer to the signal line, efficiency of heating by the heat generation element can be improved.

### Fourth Example Embodiment

Next, a switching element in a fourth example embodiment will be described with reference to the drawings. The switching element of the present example embodiment is different from the switching elements of the first to third example embodiments in that a phase transition element and a heat generation element are arranged at positions not overlapping each other in plan view. Hereinafter, description of a configuration similar to that of the first to third example embodiments will be simplified or omitted.

### (Configuration)

In the switching element of the present example embodiment, the phase transition element and the heat generation element do not overlap each other in plan view. The phase transition element and the heat generation element are thermally connected via a heat conduction layer or a heat conduction promotion layer formed on a surface of a substrate. In the present example embodiment, four configuration examples will be described regarding the switching element. Hereinafter, the configuration examples of the switching element are distinguished by adding a hyphen (-) and a number after the reference sign.

### Configuration Example 4-1

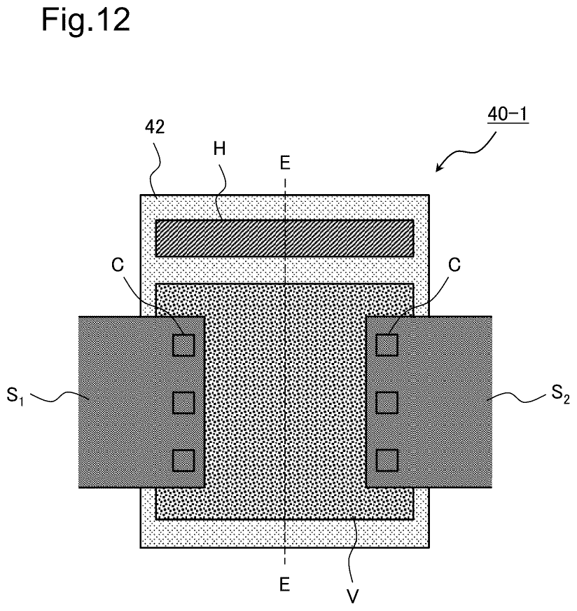

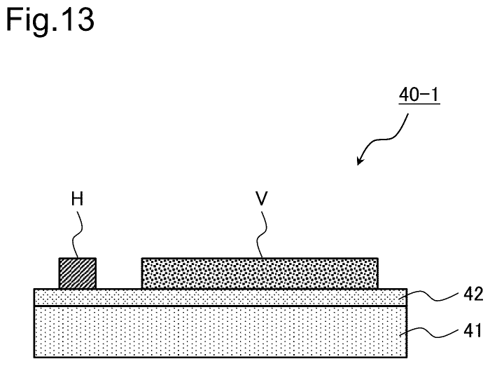

FIGS. 12 and 13 are conceptual diagrams illustrating an example of a configuration (Configuration Example 4-1) of the switching element in the present disclosure. Configuration Example 4-1 is an example in which the phase transition layer and the heat generation element are arranged on an upper surface the heat conduction layer. FIG. 12 is a plan view of the switching element viewed from an upper viewpoint. FIG. 13 is a cross-sectional view of the switching element cut along a cutting line E-E in FIG. 12.

A switching element 40-1 includes a substrate 41, a heat conduction layer 42, a phase transition layer V, and a heat generation element H. The phase transition layer V and the heat generation element H are arranged on an upper surface of the heat conduction layer 42. An insulation layer (not illustrated) may be formed above the heat conduction layer 42, the phase transition layer V, and the heat generation element H. The heat conduction layer 42 is arranged on the upper surface of the substrate 41. The phase transition layer V is electrically connected to a first signal line S₁ and a second signal line S₂ via connection ends C. For example, the first signal line S₁ and the second signal line S₂ include metal such as copper or aluminum.

The substrate 41 has a similar configuration to that of the substrate 11 of the first example embodiment. The substrate 41 is an insulator (dielectric). The substrate 41 has a thermal conductivity lower than that of the phase transition layer V.

The heat conduction layer 42 has a similar configuration to that of the heat conduction layer 12 of the first example embodiment. The heat conduction layer 42 is arranged on an upper surface of the substrate 41. The phase transition layer V and the heat generation element H are arranged on the upper surface of the heat conduction layer 42. The heat conduction layer 42 includes a material having a higher thermal conductivity than those of the substrate 41 and the phase transition layer V.

The phase transition layer V has the similar configuration to that of the phase transition layer V of the first example embodiment. The phase transition layer V is arranged on the upper surface of the heat conduction layer 42. To the phase transition layer V, heat of the heat generation element His conducted via the heat conduction layer 42. The phase transition layer V undergoes a phase transition from an insulation phase to a metal phase by heat generation of the heat generation element H. The phase transition layer V is electrically connected to the first signal line S₁ and the second signal line S₂.

The phase transition layer V includes a vanadium dioxide that undergoes the phase transition from the insulation phase to the metal phase at a phase transition temperature. The phase transition layer V is arranged between the first signal line S₁ and the second signal line S₂ and functions as a switch. The vanadium dioxide is the insulation phase at a temperature lower than the phase transition temperature. Therefore, at the temperature lower than the phase transition temperature, the switching element 40-1 is in an off state. The vanadium dioxide is the metal phase at a temperature higher than the phase transition temperature. Therefore, at the temperature higher than the phase transition temperature, the switching element 40-1 is in an on state. The resistance change in the phase transition of the insulation phase-metal phase of the vanadium dioxide indicates the hysteresis characteristics. Therefore, in consideration of the hysteresis characteristics, the temperature of the phase transition layer V is adjusted in such a way as to cross the phase transition temperature.

The heat generation element H has the similar configuration to that of the heat generation element H of the first example embodiment. The phase transition layer V and the heat generation element H are arranged on a side of the same surface relative to the substrate 41. The heat generation element H is arranged on the side of the same surface as the heat conduction layer 42. The heat generation element H is arranged on the same surface as the phase transition layer V on the upper surface of the heat conduction layer 42. The heat generation element H is arranged at an interval from the phase transition layer V. The heat generation element His thermally connected to the phase transition layer V via the heat conduction layer 42. The heat generation element H has an elongated rectangular shape along an extension direction of the first signal line S₁ and the second signal line S₂. The heat generation element His smaller than the phase transition layer V.

A temperature of the heat generation element H is controlled according to selection via a TFT circuit (not illustrated). The heat generation element H is connected to the drive circuit constituting the TFT circuit by the temperature control line. The TFT wiring includes the plurality of selection lines and the plurality of data lines. When the drive circuit connected to the heat generation element H is selected, the heat generation element H generates heat. The heat of the heat generation element His conducted to the phase transition layer V via the heat conduction layer 42 arranged on a lower surface of the heat generation element H. The resistance change in the phase transition of the insulation phase-metal phase of the vanadium dioxide indicates the hysteresis characteristics. Therefore, in consideration of the hysteresis characteristics, the temperature of the heat generation element His controlled in such a way that the temperature of the phase transition layer V crosses the phase transition temperature.

When the heat generation element H generates heat according to the selection via the TFT circuit, the heat is conducted to the heat conduction layer 42. Since the heat conduction layer 42 has the higher thermal conductivity than that of the phase transition layer V, the heat is more efficiently conducted than in the phase transition layer V. The heat conducted in the heat conduction layer 42 is conducted to the phase transition layer V arranged on the upper surface. As a result, the phase transition layer V is uniformly heated via the heat conduction layer 42 arranged on a lower surface. When the temperature of the vanadium dioxide exceeds the phase transition temperature, the vanadium dioxide undergoes the phase transition from the insulation phase to the metal phase. When the vanadium dioxide undergoes the phase transition to the metal phase, the switching element 40-1 transitions to the on state. The heat conducted to the phase transition layer V is also conducted to the first signal line S₁ and the second signal line S₂. When the heat generation of the deselected heat generation element H stops and the temperature of the vanadium dioxide falls below the phase transition temperature, the vanadium dioxide undergoes a phase transition from the metal phase to the insulation phase. When the vanadium dioxide undergoes the phase transition to the insulation phase, the switching element 40-1 transitions to the off state.

In the present configuration example, the phase transition layer V and the heat generation element H are arranged on the side of the same surface relative to the substrate 41. According to the present configuration example, a degree of freedom of a positional relationship between the phase transition layer V and the heat generation element H increases.

### Configuration Example 4-2

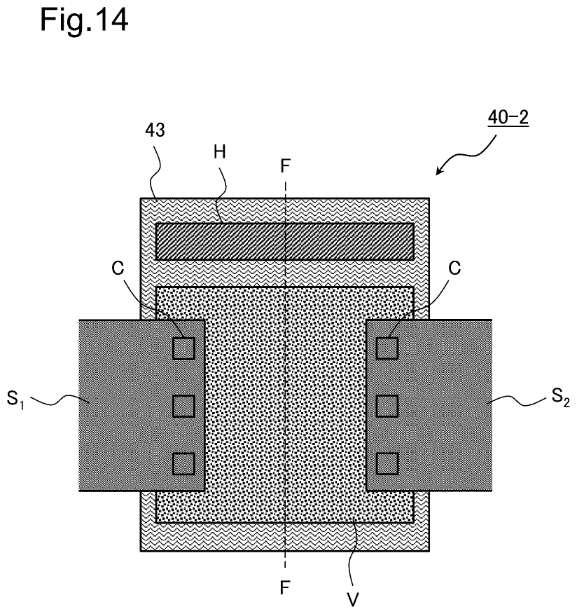

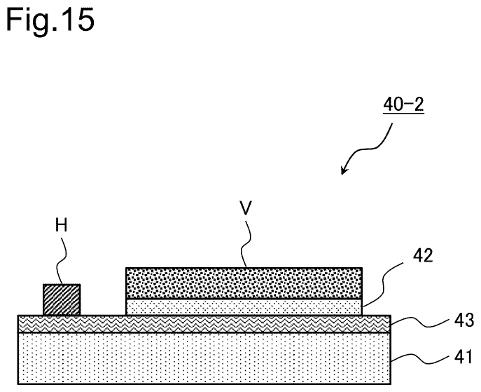

FIGS. 14 and 15 are conceptual diagrams illustrating an example of the configuration (Configuration Example 4-2) of the switching element in the present disclosure. Configuration Example 4-2 is an example in which the heat conduction layer and the heat generation element are arranged on an upper surface of the heat conduction promotion layer, and the heat generation element is arranged on the upper surface of the heat conduction layer. FIG. 14 is a plan view of the switching element viewed from the upper viewpoint. FIG. 15 is a cross-sectional view of the switching element cut along a cutting line F-F in FIG. 14.

A switching element 40-2 includes the substrate 41, the heat conduction layer 42, a heat conduction promotion layer 43, the phase transition layer V, and the heat generation element H. The phase transition layer V is arranged on an upper surface of the heat conduction layer 42. The heat generation element H is arranged on an upper surface of the heat conduction promotion layer 43. The insulation layer (not illustrated) may be formed above the heat conduction layer 42, the heat conduction promotion layer 43, the phase transition layer V, and the heat generation element H. The heat conduction layer 42 is arranged on a upper surface of the heat conduction promotion layer 43. The heat conduction promotion layer 43 is arranged on an upper surface of the substrate 41. The phase transition layer V is electrically connected to the first signal line S₁ and the second signal line S₂ via the connection ends C. For example, the first signal line S₁ and the second signal line S₂ include metal such as copper or aluminum.

The substrate 41 has the similar configuration to that of the substrate 11 of the first example embodiment. The substrate 41 is the insulator (dielectric). The substrate 41 has the thermal conductivity lower than that of the phase transition layer V.

The heat conduction layer 42 has the similar configuration to that of the heat conduction layer 12 of the first example embodiment. The heat conduction layer 42 is arranged on the upper surface of the heat conduction promotion layer 43. The phase transition layer V and the heat generation element H are arranged on the upper surface of the heat conduction layer 42. The heat conduction layer 42 includes the material having the higher thermal conductivity than those of the substrate 41 and the phase transition layer V and having the lower thermal conductivity than that of the heat conduction promotion layer 43.

The heat conduction promotion layer 43 has a similar configuration to that of the heat conduction promotion layer 13 of the first example embodiment. The heat conduction promotion layer 43 is arranged on the upper surface of the substrate 41. The heat conduction layer 42 and the heat generation element H are arranged on the upper surface of the heat conduction promotion layer 43. The heat conduction promotion layer 43 includes a material having the higher thermal conductivity than those of the substrate 41 and the heat conduction layer 42.

The phase transition layer V has the similar configuration to that of the phase transition layer V of the first example embodiment. The phase transition layer V is arranged on the upper surface of the heat conduction layer 42. To the phase transition layer V, heat of the heat generation element H is conducted via the heat conduction layer 42. The phase transition layer V undergoes the phase transition from the insulation phase to the metal phase by heat generation of the heat generation element H. The phase transition layer V is electrically connected to the first signal line S₁ and the second signal line S₂.

The phase transition layer V includes the vanadium dioxide that undergoes the phase transition from the insulation phase to the metal phase at the phase transition temperature. The phase transition layer V is arranged between the first signal line S₁ and the second signal line S₂ and functions as a switch. The vanadium dioxide is the insulation phase at the temperature lower than the phase transition temperature. Therefore, at the temperature lower than the phase transition temperature, the switching element 40-2 is in an off state. The vanadium dioxide is the metal phase at the temperature higher than the phase transition temperature. Therefore, at the temperature higher than the phase transition temperature, the switching element 40-2 is in an on state. The resistance change in the phase transition of the insulation phase-metal phase of the vanadium dioxide indicates the hysteresis characteristics. Therefore, in consideration of the hysteresis characteristics, the temperature of the phase transition layer V is adjusted in such a way as to cross the phase transition temperature.

The heat generation element H has the similar configuration to that of the heat generation element H of the first example embodiment. The heat generation element H is arranged on the upper surface of the heat conduction promotion layer 43. The heat generation element H has the similar configuration to that of the heat generation element H of the first example embodiment. The heat generation element H is arranged on the upper surface of the heat conduction promotion layer 43. The heat generation element H is arranged on the same surface as the heat conduction layer 42 on the upper surface of the heat conduction layer 42. The heat generation element H is arranged at an interval from the heat conduction layer 42. The heat generation element H is thermally connected to the phase transition layer V via the heat conduction layer 42 and the heat conduction promotion layer 43. The heat generation element H has the elongated rectangular shape along the extension direction of the first signal line S₁ and the second signal line S₂. The heat generation element H is smaller than the phase transition layer V.

The temperature of the heat generation element H is controlled according to the selection via the TFT circuit (not illustrated). The heat generation element H is connected to the drive circuit constituting the TFT circuit by the temperature control line. The TFT wiring includes the plurality of selection lines and the plurality of data lines. When the drive circuit connected to the heat generation element H is selected, the heat generation element H generates heat. The heat of the heat generation element His conducted to the heat conduction layer 42 via the heat conduction promotion layer 43 arranged on the lower surface of the heat generation element H. The heat conducted to the heat conduction layer 42 is conducted to the phase transition layer V via the heat conduction layer 42. The resistance change in the phase transition of the insulation phase-metal phase of the vanadium dioxide indicates the hysteresis characteristics. Therefore, in consideration of the hysteresis characteristics, the temperature of the heat generation element His controlled in such a way that the temperature of the phase transition layer V crosses the phase transition temperature.

When the heat generation element H generates heat according to the selection via the TFT circuit, the heat is conducted to the heat conduction promotion layer 43. The heat conducted to the heat conduction promotion layer 43 is conducted in the heat conduction promotion layer 43 and is conducted to the heat conduction layer 42 arranged on the upper surface. Since the heat conduction layer 42 has the higher thermal conductivity than that of the phase transition layer V, the heat is more efficiently conducted than in the phase transition layer V. The heat conducted in the heat conduction layer 42 is conducted to the phase transition layer V arranged on the upper surface. As a result, the phase transition layer V is uniformly heated via the heat conduction layer 42 arranged on the lower surface. When the temperature of the vanadium dioxide exceeds the phase transition temperature, the vanadium dioxide undergoes the phase transition from the insulation phase to the metal phase. When the vanadium dioxide undergoes the phase transition to the metal phase, the switching element 40-2 transitions to the on state. The heat conducted to the phase transition layer V is also conducted to the first signal line S₁ and the second signal line S₂. When the heat generation of the deselected heat generation element H stops and the temperature of the vanadium dioxide falls below the phase transition temperature, the vanadium dioxide undergoes the phase transition from the metal phase to the insulation phase. When the vanadium dioxide undergoes the phase transition to the insulation phase, the switching element 40-2 transitions to the off state.

In the present configuration example, the phase transition layer V and the heat generation element H are arranged on the side of the same surface relative to the substrate 41. In the present configuration example, the heat of the heat generation element H is conducted to the phase transition layer V via the heat conduction promotion layer 43 having the higher thermal conductivity than that of the heat conduction layer 42. Therefore, according to the present configuration example, the phase transition layer V can be efficiently heated as compared with Configuration Example 4-1.

### Configuration Example 4-3

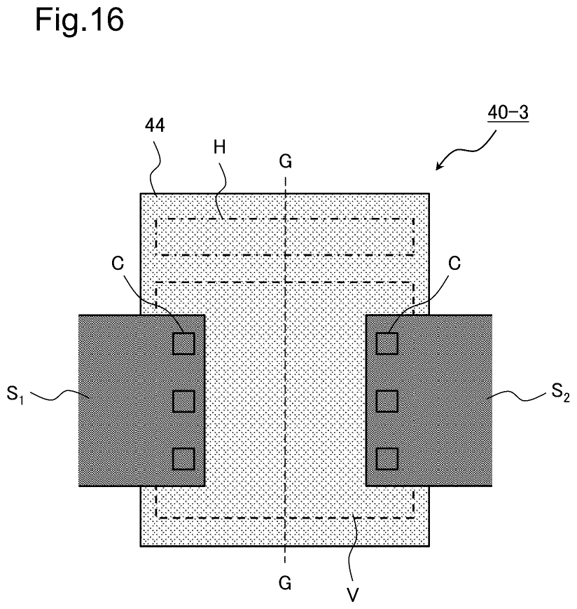

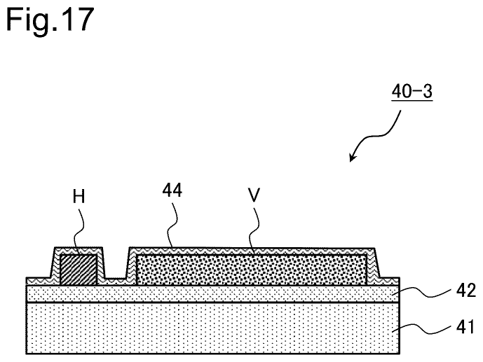

FIGS. 16 and 17 are conceptual diagrams illustrating an example of the configuration (Configuration Example 4-3) of the switching element in the present disclosure. Configuration Example 4-3 is an example in which the phase transition layer and the heat generation element are arranged on the upper surface of the heat conduction layer, and surfaces of the heat generation element and the heat generation element are covered with the heat conduction promotion layer. FIG. 16 is a plan view of the switching element viewed from the upper viewpoint. FIG. 17 is a cross-sectional view of the switching element cut along a cutting line G-G in FIG. 16.

A switching element 40-3 includes the substrate 41, the heat conduction layer 42, a heat conduction promotion layer 44, the phase transition layer V, and the heat generation element H. Upper surfaces of the phase transition layer V and the heat generation element H are covered with the heat conduction promotion layer 44. The heat conduction layer 42 is arranged below the heat conduction promotion layer 44. The heat conduction layer 42 is arranged on the upper surface of the substrate 41. The insulation layer (not illustrated) may be formed above the heat conduction layer 42, the heat conduction promotion layer 44, the phase transition layer V, and the heat generation element H. The phase transition layer V is electrically connected to the first signal line S₁ and the second signal line S₂ via the connection ends C. For example, the first signal line S₁ and the second signal line S₂ include metal such as copper or aluminum.

The substrate 41 has the similar configuration to that of the substrate 11 of the first example embodiment. The substrate 41 is the insulator (dielectric). The substrate 41 has the thermal conductivity lower than that of the phase transition layer V.

The heat conduction layer 42 has a similar configuration to that of the heat conduction layer 12 of the first example embodiment. The heat conduction layer 42 is arranged on an upper surface of the substrate 41. The phase transition layer V and the heat generation element H are arranged on the upper surface of the heat conduction layer 42. An upper portion of the heat conduction layer 42 is covered with the heat conduction promotion layer 44. The heat conduction layer 42 includes the material having the higher thermal conductivity than those of the substrate 41 and the phase transition layer V and having the lower thermal conductivity than that of the heat conduction promotion layer 44.

The heat conduction promotion layer 44 covers the upper surfaces of the heat conduction layer 42, the phase transition layer V, and the heat generation element H. The heat conduction promotion layer 44 includes a material having a higher thermal conductivity than those of the substrate 41, the heat conduction layer 42, and the phase transition layer V. The material of the heat conduction promotion layer 44 is not limited as long as it includes the material having the higher thermal conductivity than those of the substrate 41, the heat conduction layer 42, and the phase transition layer V. For example, the heat conduction promotion layer 44 includes silicon carbide. The silicon carbide has a crystal system whose thermal conductivity is comparable to that of metal.

The phase transition layer V has the similar configuration to that of the phase transition layer V of the first example embodiment. The phase transition layer V is arranged on the upper surface of the heat conduction layer 42. To the phase transition layer V, heat of the heat generation element His conducted via the heat conduction layer 42. The phase transition layer V is covered with the heat conduction promotion layer 44. In the phase transition layer V, heat of the heat generation element H is conducted via the heat conduction promotion layer 44. That is, the heat from the heat conduction layer 42 on the lower surface and the heat from the heat conduction promotion layer 44 on the upper surface are conducted to the phase transition layer V. The phase transition layer V undergoes the phase transition from the insulation phase to the metal phase by heat generation of the heat generation element H. The phase transition layer V is electrically connected to the first signal line S₁ and the second signal line S₂ via metal layers M.

The phase transition layer V includes the vanadium dioxide that undergoes the phase transition from the insulation phase to the metal phase at the phase transition temperature. The phase transition layer V is arranged between the first signal line S₁ and the second signal line S₂ and functions as a switch. The vanadium dioxide is the insulation phase at the temperature lower than the phase transition temperature. Therefore, at the temperature lower than the phase transition temperature, the switching element 40-3 is in an off state. The vanadium dioxide is the metal phase at the temperature higher than the phase transition temperature. Therefore, at the temperature higher than the phase transition temperature, the switching element 40-3 is in an on state. The resistance change in the phase transition of the insulation phase-metal phase of the vanadium dioxide indicates the hysteresis characteristics. Therefore, in consideration of the hysteresis characteristics, the temperature of the phase transition layer V is adjusted in such a way as to cross the phase transition temperature.

The heat generation element H has the similar configuration to that of the heat generation element H of the first example embodiment. The heat generation element H is arranged on the upper surface of the heat conduction layer 42. The heat generation element H is arranged on the same surface as the phase transition layer V on the upper surface of the heat conduction layer 42. The heat generation element H is arranged at an interval from the phase transition layer V. The heat generation element His thermally connected to the phase transition layer V via the heat conduction layer 42 and the heat conduction promotion layer 44. The heat generation element H is covered with the heat conduction promotion layer 44. The heat generation element His thermally connected to the phase transition layer V via the heat conduction layer 42 and the heat conduction promotion layer 44. The heat generation element H has the elongated rectangular shape along the extension direction of the first signal line S₁ and the second signal line S₂. The heat generation element H is smaller than the phase transition layer V.

The temperature of the heat generation element H is controlled according to selection via the TFT circuit (not illustrated). The heat generation element H is connected to the drive circuit constituting the TFT circuit by the temperature control line. The TFT wiring includes the plurality of selection lines and the plurality of data lines. When the drive circuit connected to the heat generation element H is selected, the heat generation element H generates heat. The heat of the heat generation element His conducted to the phase transition layer V via the heat conduction layer 42 and the heat conduction promotion layer 44. The resistance change in the phase transition of the insulation phase-metal phase of the vanadium dioxide indicates the hysteresis characteristics. Therefore, in consideration of the hysteresis characteristics, the temperature of the heat generation element H is controlled in such a way that the temperature of the phase transition layer V crosses the phase transition temperature.

When the heat generation element H generates heat according to the selection via the TFT circuit, the heat is conducted to the heat conduction layer 42 and the heat conduction promotion layer 44. The heat conducted to the heat conduction layer 42 is conducted in the heat conduction layer 42 and is conducted to the phase transition layer V arranged on the upper surface. Since the heat conduction layer 42 has the higher thermal conductivity than that of the phase transition layer V, the heat is more efficiently conducted than in the phase transition layer V. The heat conducted to the heat conduction promotion layer 44 is conducted in the heat conduction promotion layer 44 and is conducted to the phase transition layer V arranged below. Since the heat conduction promotion layer 44 has the higher thermal conductivity than that of the phase transition layer V, the heat is more efficiently conducted than in the phase transition layer V. As a result, the phase transition layer V is efficiently heated via the heat conduction layer 42 arranged on the lower surface and the heat conduction promotion layer 44 covering the upper surface. When the temperature of the vanadium dioxide exceeds the phase transition temperature, the vanadium dioxide undergoes the phase transition from the insulation phase to the metal phase. When the vanadium dioxide undergoes the phase transition to the metal phase, the switching element 40-3 transitions to the on state. The heat conducted to the phase transition layer V is also conducted to the first signal line S₁ and the second signal line S₂. When the heat generation of the deselected heat generation element H stops and the temperature of the vanadium dioxide falls below the phase transition temperature, the vanadium dioxide undergoes the phase transition from the metal phase to the insulation phase. When the vanadium dioxide undergoes the phase transition to the insulation phase, the switching element 40-3 transitions to the off state.

In the present configuration example, the phase transition layer V and the heat generation element H are arranged on the side of the same surface relative to the substrate 41. In the present configuration example, the phase transition layer V is sandwiched between the heat conduction layer 42 and the heat conduction promotion layer 44. Therefore, according to the present configuration example, the phase transition layer V can be efficiently heated as compared with Configuration Examples 4-1 and 4-2.

### Configuration Example 4-4

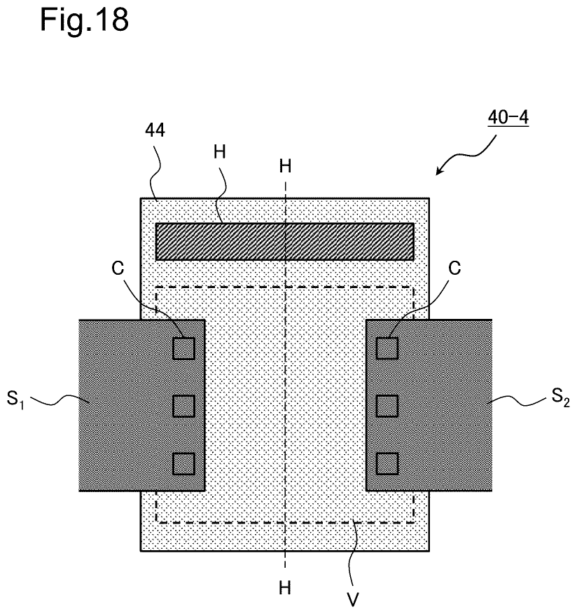

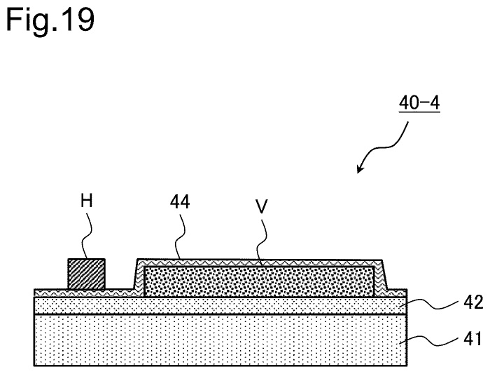

FIGS. 18 and 19 are conceptual diagrams illustrating an example of the configuration (Configuration Example 4-4) of the switching element in the present disclosure. Configuration Example 4-4 is an example in which the phase transition layer is arranged on the upper surface of the heat conduction layer, the surfaces of the heat conduction layer and the phase transition layer are covered with the heat conduction promotion layer, and the heat generation element is arranged on the upper surface of the heat conduction promotion layer. FIG. 18 is a plan view of the switching element viewed from the upper viewpoint. FIG. 19 is a cross-sectional view of the switching element cut along a cutting line H-H in FIG. 18.

A switching element 40-4 includes the substrate 41, the heat conduction layer 42, the heat conduction promotion layer 44, the phase transition layer V, and the heat generation element H. The phase transition layer V is arranged on a lower surface of the heat conduction promotion layer 44. When viewed from the upper viewpoint, the heat generation element H is arranged on an upper surface of the heat conduction promotion layer 44. The heat conduction layer 42 is arranged below the heat conduction promotion layer 44. The heat conduction layer 42 is arranged on the upper surface of the substrate 41. The insulation layer (not illustrated) may be formed above the heat conduction layer 42, the heat conduction promotion layer 44, the phase transition layer V, and the heat generation element H. The phase transition layer V is electrically connected to the first signal line S₁ and the second signal line S₂ via the connection ends C. In the drawing, the heat generation element H is arranged above the phase transition layer V. For example, the first signal line S₁ and the second signal line S₂ include metal such as copper or aluminum.

The substrate 41 has the similar configuration to that of the substrate 11 of the first example embodiment. The substrate 41 is the insulator (dielectric). The substrate 41 has the thermal conductivity lower than that of the phase transition layer V.

The heat conduction layer 42 has the similar configuration to that of the heat conduction layer 12 of the first example embodiment. The heat conduction layer 42 is arranged on the upper surface of the substrate 41. The phase transition layer V is arranged on the upper surface of the heat conduction layer 42. The heat conduction layer 42 includes the material having the higher thermal conductivity than those of the substrate 41 and the phase transition layer V and having the lower thermal conductivity than that of the heat conduction promotion layer 44.

The heat conduction promotion layer 44 has a similar configuration to that of the heat conduction promotion layer 44 of Configuration Example 4-3. The heat conduction promotion layer 44 covers the upper surfaces of the heat conduction layer 42 and the phase transition layer V. The heat conduction promotion layer 44 includes the material having the higher thermal conductivity than those of the substrate 41, the heat conduction layer 42, and the phase transition layer V.

The phase transition layer V has the similar configuration to that of the phase transition layer V of the first example embodiment. The phase transition layer V is arranged on the upper surface of the heat conduction layer 42. To the phase transition layer V, heat of the heat generation element His conducted via the heat conduction layer 42. The phase transition layer V is covered with the heat conduction promotion layer 44. In the phase transition layer V, heat of the heat generation element H is conducted via the heat conduction promotion layer 44. That is, the heat from the heat conduction layer 42 on the lower surface and the heat from the heat conduction promotion layer 44 on the upper surface are conducted to the phase transition layer V. The phase transition layer V undergoes the phase transition from the insulation phase to the metal phase by heat generation of the heat generation element H. The phase transition layer V is electrically connected to the first signal line S₁ and the second signal line S₂ via the metal layers M.

The phase transition layer V includes the vanadium dioxide that undergoes the phase transition from the insulation phase to the metal phase at the phase transition temperature. The phase transition layer V is arranged between the first signal line S₁ and the second signal line S₂ and functions as a switch. The vanadium dioxide is the insulation phase at the temperature lower than the phase transition temperature. Therefore, at the temperature lower than the phase transition temperature, the switching element 40-4 is in an off state. The vanadium dioxide is the metal phase at the temperature higher than the phase transition temperature. Therefore, at the temperature higher than the phase transition temperature, the switching element 40-4 is in an on state. The resistance change in the phase transition of the insulation phase-metal phase of the vanadium dioxide indicates the hysteresis characteristics. Therefore, in consideration of the hysteresis characteristics, the temperature of the phase transition layer V is adjusted in such a way as to cross the phase transition temperature.

The heat generation element H has the similar configuration to that of the heat generation element H of the first example embodiment. The heat generation element H is arranged on the upper surface of the heat conduction promotion layer 44. The heat generation element His arranged on a side of the same surface as the phase transition layer V relative to the upper surface of the heat conduction layer 42. The heat generation element H is arranged at an interval from the phase transition layer V. The heat generation element His thermally connected to the phase transition layer V via the heat conduction layer 42 and the heat conduction promotion layer 44. The heat generation element H has the elongated rectangular shape along the extension direction of the first signal line S₁ and the second signal line S₂. The heat generation element His smaller than the phase transition layer V.

The temperature of the heat generation element H is controlled according to selection via the TFT circuit (not illustrated). The heat generation element H is connected to the drive circuit constituting the TFT circuit by the temperature control line. The TFT wiring includes the plurality of selection lines and the plurality of data lines. When the drive circuit connected to the heat generation element H is selected, the heat generation element H generates heat. The heat of the heat generation element His conducted to the heat conduction layer 42 and the phase transition layer V via the heat conduction promotion layer 44. The resistance change in the phase transition of the insulation phase-metal phase of the vanadium dioxide indicates the hysteresis characteristics. Therefore, in consideration of the hysteresis characteristics, the temperature of the heat generation element H is controlled in such a way that the temperature of the phase transition layer V crosses the phase transition temperature.

When the heat generation element H generates heat according to the selection via the TFT circuit, the heat is conducted to the heat conduction promotion layer 44. The heat conducted to the heat conduction promotion layer 44 is conducted in the heat conduction promotion layer 44 and is conducted to the phase transition layer V and the heat conduction layer 42 arranged on the lower surface. Since the heat conduction layer 42 and the heat conduction promotion layer 44 have the higher thermal conductivities than that of the phase transition layer V, the heat is more efficiently conducted than in the phase transition layer V. As a result, the phase transition layer V is efficiently heated via the heat conduction layer 42 arranged on the lower surface and the heat conduction promotion layer 44 covering the upper surface. When the temperature of the vanadium dioxide exceeds the phase transition temperature, the vanadium dioxide undergoes the phase transition from the insulation phase to the metal phase. When the vanadium dioxide undergoes the phase transition to the metal phase, the switching element 40-4 transitions to the on state. The heat conducted to the phase transition layer V is also conducted to the first signal line S₁ and the second signal line S₂. When the heat generation of the deselected heat generation element H stops and the temperature of the vanadium dioxide falls below the phase transition temperature, the vanadium dioxide undergoes the phase transition from the metal phase to the insulation phase. When the vanadium dioxide undergoes the phase transition to the insulation phase, the switching element 40-4 transitions to the off state.

In the present configuration example, the phase transition layer V and the heat generation element H are arranged on the side of the same surface relative to the substrate 41. In the present configuration example, the phase transition layer V is sandwiched between the heat conduction layer 42 and the heat conduction promotion layer 44. Therefore, according to the present configuration example, the phase transition layer V can be efficiently heated, similarly to Configuration Example 4-3.

As described above, the switching element of the present example embodiment includes the substrate, the phase transition layer, the heat conduction layer, and the heat generation element. The substrate is the insulator having the lower thermal conductivity than those of the phase transition layer and the heat conduction layer. The phase transition layer includes the substance that undergoes the metal-insulator phase transition. For example, the phase transition layer includes the vanadium dioxide as the substance that undergoes the metal-insulator phase transition. The phase transition layer is arranged in the signal lines through which the signals to be transmitted and received propagate. In the phase transition layer, portions connected to the signal lines are metal vanadium. The heat conduction layer is the insulator having the higher thermal conductivity than that of the phase transition layer. The heat conduction layer is formed between the substrate and the phase transition layer. The heat generation element has the rectangular shape having a long side along the direction perpendicular to the extension direction of the signal lines and a short side shorter than a side length of the phase transition layer. The heat generation element is thermally connected to the phase transition layer and the heat conduction layer. The phase transition layer and the heat generation element are arranged at an interval on the same surface of the heat conduction layer.

In the switching element of the present example embodiment, the phase transition layer and the heat generation element are arranged at an interval on the same surface of the heat conduction layer. The heat of the heat generation element is conducted to the phase transition layer via the heat conduction layer. According to the present example embodiment, the phase transition layer and the heat generation element can be arranged on the side of the same surface relative to the substrate on which the heat conduction layer is formed by heat conduction via the heat conduction layer.

In an aspect of the present example embodiment, at least one of the phase transition layer, the heat generation element, and the heat conduction layer is covered with the heat conduction promotion layer that is the insulator having the higher thermal conductivity than that of the heat conduction layer. For example, the phase transition layer, the heat generation element, and the heat conduction layer are covered with the heat conduction promotion layer. For example, the phase transition layer and the heat conduction layer are covered with the heat conduction promotion layer, and the heat generation element is arranged on the upper surface of the heat conduction promotion layer. According to the present aspect, the phase transition layer can be more efficiently subjected to the phase transition by using the heat conduction promotion layer.

The switching element of an aspect of the present example embodiment includes the heat conduction promotion layer that is the insulator having the higher thermal conductivity than that of the heat conduction layer and is thermally connected to the phase transition layer. The phase transition layer and the heat generation element are arranged at an interval on the side of the same surface of the heat conduction promotion layer. For example, the heat conduction layer is arranged between the phase transition layer and the heat conduction promotion layer. According to the present aspect, the phase transition layer can be more efficiently subjected to the phase transition by using the heat conduction promotion layer.

### Fifth Example Embodiment

Next, a phase shifter according to a fifth example embodiment will be described with reference to the drawings. For example, the phase shifter of the present example embodiment is mounted on a planar antenna including a plurality of patch antennas. When the planar antenna including the phase shifter of the present example embodiment is achieved, a phased array antenna that transmits a radio wave having directivity can be configured. Such a planar antenna is used for transmission/reception of electromagnetic waves in a high frequency band predicted to be applied to mobile communication of Beyond 5 Generation (B5G) following 5 Generation (5G). The phase shifter of the present example embodiment is not limited to be mounted on the planar antenna, and can be mounted on any device.

### (Configuration)

The phase shifter of the present example embodiment has a structure in which the switching elements in the first to fourth example embodiments are coupled. For example, the switching elements in the first to fourth example embodiments are applied to an extension structure used for extending a signal line or the like of the phase shifter. In the present example embodiment, two configuration examples will be described regarding the extension structure of the phase shifter. Hereinafter, the configuration examples of the extension structure of the phase shifter are distinguished by adding a hyphen (-) and a number after a reference sign.

For example, the phase shifter is a line length variable phase shifter in which a plurality of phase shift wirings having different line lengths are branched from a main wiring in a side chain form. For example, the phase shift wiring is a stub having an open end. An openable/closable selection switch (not illustrated) is arranged at a contact point between the plurality of phase shift wiring and the main wiring. The phase shift wiring is selected according to opening/closing of the selection switch arranged at the contact point with the main wiring. The selection switch may include a phase transition switch.

### Configuration Example 5-1

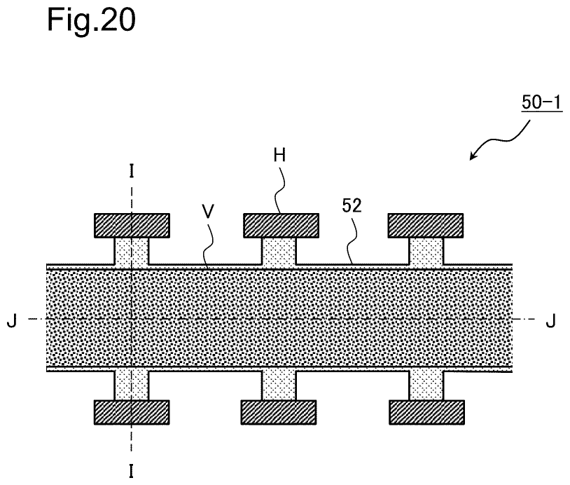

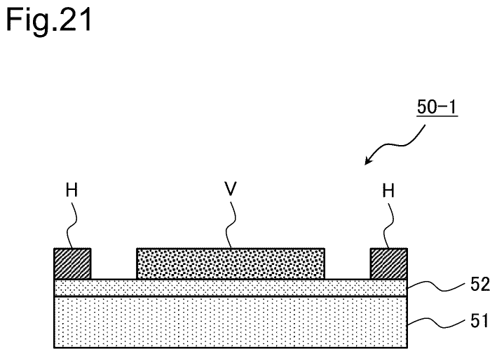

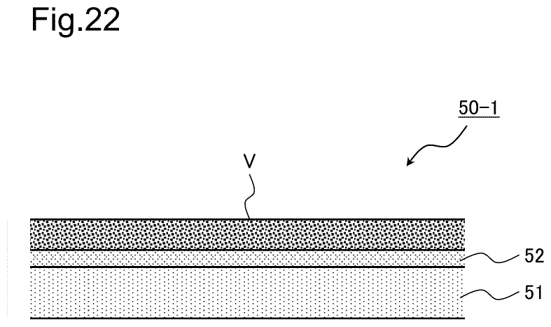

FIGS. 20 to 22 are conceptual diagrams illustrating an example of the extension structure (Configuration Example 5-1) of the phase shifter in the present disclosure. Configuration Example 5-1 is an example in which a heat conduction layer included in a plurality of switching elements is not divided for each element. FIG. 20 is a plan view of a portion (phase shift wiring) of the phase shifter viewed from an upper viewpoint. FIG. 21 is a cross-sectional view cut along a cutting line I-I in FIG. 20. FIG. 22 is a cross-sectional view cut along a cutting line J-J in FIG. 20. FIGS. 20 to 22 illustrate a part of the phase shift wiring capable of extending the line length according to selection of a heat generation element.

A phase shift wiring 50-1 includes a substrate 51, a heat conduction layer 52, a phase transition layer V, and a plurality of heat generation elements H. A single switching element includes two heat generation elements H opposing each other in a direction perpendicular to an extension direction of the phase shift wiring 50-1 and a portion of the phase transition layer V that undergoes a phase transition to a metal phase according to heat generation of the heat generation elements H. The two heat generation elements H opposing each other in the direction perpendicular to the extension direction of the phase shift wiring 50-1 configure a heat generation element pair. In FIGS. 20 to 22, signal lines and other wirings are omitted.

The substrate 51 has a similar configuration to that of the substrate 11 of the first example embodiment. The substrate 51 is an insulator (dielectric). The substrate 51 has a thermal conductivity lower than that of the phase transition layer V. The substrate 51 is extended along the extension direction of the phase shift wiring 50-1.

The heat conduction layer 52 has a similar configuration to that of the heat conduction layer 12 of the first example embodiment. The heat conduction layer 52 is arranged on an upper surface of the substrate 51. The phase transition layer V is arranged on an upper surface of the heat conduction layer 52. The heat conduction layer 52 includes a material having a higher thermal conductivity than those of the substrate 51 and the phase transition layer V. The heat conduction layer 52 may be combined with a heat conduction promotion layer. The heat conduction layer 52 is extended on the upper surface of the substrate 51 along the extension direction of the phase shift wiring 50-1.

The phase transition layer V has the similar configuration to that of the phase transition layer V of the first example embodiment. The phase transition layer V is different from the phase transition layer V of the first example embodiment in that the phase transition layer V is extended on the upper surface of the heat conduction layer 52 along the extension direction of the phase shift wiring 50-1. The phase transition layer V includes a vanadium dioxide that undergoes the phase transition from the insulation phase to the metal phase at a phase transition temperature. The phase transition layer V is arranged on the upper surface of the heat conduction layer 52. The phase transition layer V is extended on the upper surface of the substrate 51 along the extension direction of the phase shift wiring 50-1. To the phase transition layer V, heat of the two heat generation elements H configuring the heat generation element pair is conducted via the heat conduction layer 52. The phase transition layer V undergoes the phase transition from the insulation phase to the metal phase by heat generation of the two heat generation elements H configuring the heat generation element pair.

The vanadium dioxide is the insulation phase at a temperature lower than the phase transition temperature. Therefore, at the temperature lower than the phase transition temperature, the switching element is in an off state. The vanadium dioxide is the metal phase at a temperature higher than the phase transition temperature. Therefore, at the temperature higher than the phase transition temperature, the switching element is in an on state. The resistance change in the phase transition of the insulation phase-metal phase of the vanadium dioxide indicates the hysteresis characteristics. Therefore, in consideration of the hysteresis characteristics, the temperature of the phase transition layer V is adjusted in such a way as to cross the phase transition temperature.

The heat generation element H has the similar configuration to that of the heat generation element H of the first example embodiment. The heat generation element H is arranged on the upper surface of the heat conduction layer 52. The heat generation element H and the phase transition layer V are arranged above the substrate 51. The heat generation element His arranged at an interval from the phase transition layer V. The heat generation element H has an elongated rectangular shape along the direction perpendicular to the extension direction of the phase shift wiring 50-1. The heat generation element H is smaller than the phase transition layer V. A temperature of the heat generation element H is controlled according to selection via a TFT circuit (not illustrated). The heat generation element H is connected to a drive circuit (not illustrated) constituting the TFT circuit by a temperature control line. A TFT wiring includes a plurality of selection lines and a plurality of data lines. The two heat generation elements H constituting the heat generation element pair are connected to the same drive circuit. When the drive circuit connected to the two paired heat generation elements His selected, the heat generation elements H generate heat. The heat of the heat generation elements H is conducted to the phase transition layer V via the heat conduction layer 52 arranged on lower surfaces of the heat generation elements H. The resistance change in the phase transition of the insulation phase-metal phase of the vanadium dioxide indicates the hysteresis characteristics. Therefore, in consideration of the hysteresis characteristics, the temperature of the heat generation element His controlled in such a way that the temperature of the phase transition layer V crosses the phase transition temperature.

A line length of the phase shift wiring 50-1 is set according to selection control of the heat generation element H. The heat conduction layer 52 and the phase transition layer V are arranged across the plurality of switching elements. The phase transition layer V is thermally connected to the heat generation element H via the heat conduction layer 52. The phase transition layer V generates heat according to a selection situation of the plurality of heat generation elements H.

When the selection switch arranged at the contact point with the main wiring is selected and a transition to an on state is performed, the phase shift wiring 50-1 connected to the main wiring via the selection switch transitions to an on state. When the heat generation element H connected to the phase shift wiring 50-1 generates heat, the heat is conducted to the phase transition layer V via the heat conduction layer 52 thermally connected to the heat generation element H. When the temperature of the phase transition layer V exceeds the phase transition temperature of the insulation phase-metal phase, the phase transition layer V transitions to the metal phase. The phase transition layer V that has undergone the phase transition to the metal phase functions as a line of the phase shift wiring.

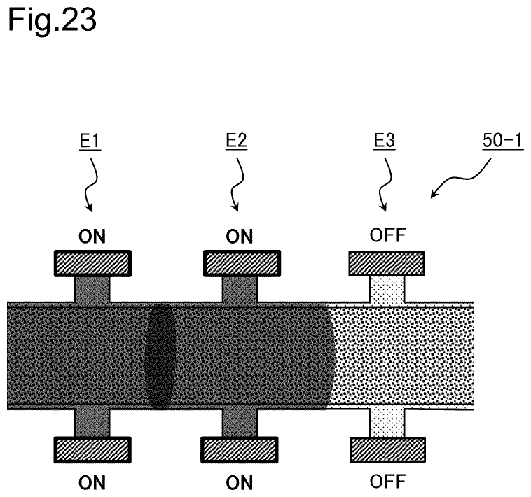

FIG. 23 is a conceptual diagram illustrating an example of the heat conduction in the extension structure of the phase shifter in the present disclosure. FIG. 23 illustrates three switching elements. In the example of FIG. 23, a portion of the phase transition layer V in an insulation phase state and a portion of the phase transition layer Vin a metal phase state are indicated by different hatching. A switching element E1 and a switching element E2 are in an on state. The phase transition layer V in portions of the switching element E1 and the switching element E2 is in the metal phase state. A switching element E3 is in an off state. The phase transition layer Vin a portion of the switching element E3 is in the insulation phase state. In a case where there is the contact point with the main wiring on the left side (drawing) of the phase shift wiring 50-1, the line length of the phase shift wiring 50-1 extends from the contact point with the main wiring (not illustrated) to the switching element E2. Heat of the heat generation element H for heating the adjacent switching elements is conducted to a portion of the phase transition layer V positioned at a boundary between the switching element E1 and the switching element E2.

A phase of a signal propagated from a signal source (not illustrated) to the patch antenna (not illustrated) via the phase shift wiring 50-1 undergoes the phase shift according to the line length of the phase shift wiring 50-1 that has undergone the phase transition to the metal phase. When the temperature of the phase transition layer V falls below the phase transition temperature of the insulation phase-metal phase, the phase transition layer V undergoes the phase transition to the insulation phase, and the line length of the phase shift wiring 50-1 becomes short. When a transition is performed to an off state where the selection switch arranged at the contact point with the main wiring is deselected, the phase shift wiring 50-1 connected to the main wiring via the selection switch transitions to an off state.

### Configuration Example 5-2

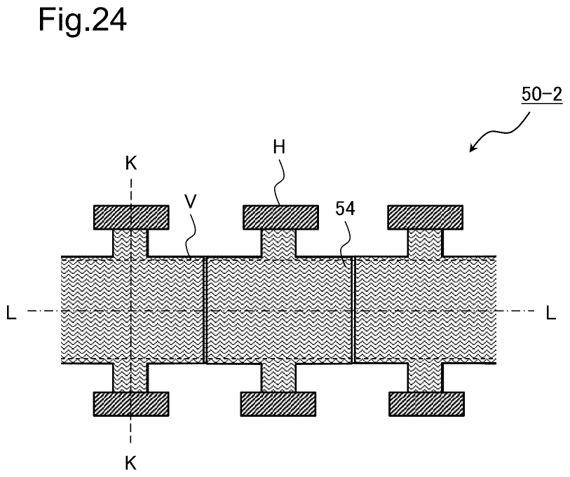

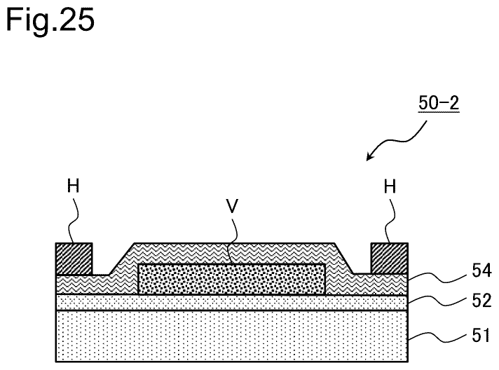

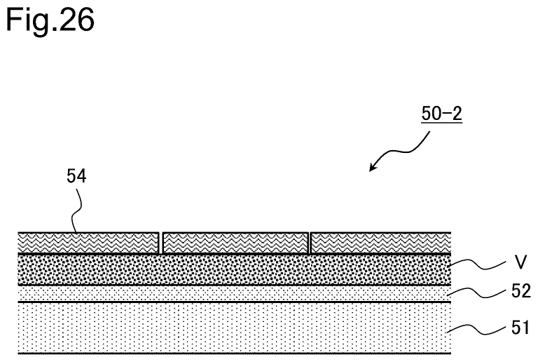

FIGS. 24 to 26 are conceptual diagrams illustrating an example of the extension structure (Configuration Example 5-2) of the phase shifter in the present disclosure. Configuration Example 5-2 is an example in which the heat conduction layer included in the plurality of switching elements is divided for each element. FIG. 24 is a plan view of a portion (phase shift wiring) of the phase shifter viewed from the upper viewpoint. FIG. 25 is a cross-sectional view cut along a cutting line K-K in FIG. 24. FIG. 26 is a cross-sectional view cut along a cutting line L-L in FIG. 24. The extension structure of the phase shifter of the present configuration example is different from the extension structure of the phase shifter of Configuration Example 5-1 in that the phase transition layer and the heat conduction layer are covered with the heat conduction promotion layer. FIGS. 24 to 26 illustrate a part of the phase shift wiring capable of extending the line length according to selection of the heat generation element.

A phase shift wiring 50-2 includes the substrate 51, the heat conduction layer 52, a heat conduction promotion layer 54, the phase transition layer V, and the plurality of heat generation elements H. A single switching element includes two heat generation elements H opposing each other in a direction perpendicular to an extension direction of the phase shift wiring 50-2 and a portion of the phase transition layer V that undergoes the phase transition to the metal phase according to heat generation of the heat generation elements H. The two heat generation elements H opposing each other in the direction perpendicular to the extension direction of the phase shift wiring 50-2 configure a heat generation element pair. In FIGS. 24 to 26, signal lines and other wirings are omitted.

The substrate 51 has the similar configuration to that of the substrate 11 of the first example embodiment. The substrate 51 is the insulator (dielectric). The substrate 51 has the thermal conductivity lower than that of the phase transition layer V. The substrate 51 is extended along the extension direction of the phase shift wiring 50-2.

The heat conduction layer 52 has the similar configuration to that of the heat conduction layer 12 of the first example embodiment. The heat conduction layer 52 is arranged on the upper surface of the substrate 51. The phase transition layer V is arranged on the upper surface of the heat conduction layer 52. A part of the upper surface of the heat conduction layer 52 is covered with the heat conduction promotion layer 54. The heat conduction layer 52 includes the material having the higher thermal conductivity than those of the substrate 51 and the phase transition layer V and having the lower thermal conductivity than that of the heat conduction promotion layer 54. The heat conduction layer 52 is extended on the upper surface of the substrate 51 along the extension direction of the phase shift wiring 50-2.

The phase transition layer V has the similar configuration to that of the phase transition layer V of the first example embodiment. The phase transition layer V is different from the phase transition layer V of the first example embodiment in that the phase transition layer V is extended on the upper surface of the heat conduction layer 52 along the extension direction of the phase shift wiring 50-2. The phase transition layer V includes the vanadium dioxide that undergoes the phase transition from the insulation phase to the metal phase at the phase transition temperature. The phase transition layer V is arranged on the upper surface of the heat conduction layer 52. The phase transition layer V is extended on the upper surface of the substrate 51 along the extension direction of the phase shift wiring 50-2. The phase transition layer V is covered with the heat conduction promotion layer 54. To the phase transition layer V, heat of the two heat generation elements H configuring the heat generation element pair is conducted via the heat conduction layer 52 and the heat conduction promotion layer 54. The phase transition layer V undergoes the phase transition from the insulation phase to the metal phase by heat generation of the two heat generation elements H configuring the heat generation element pair.

The vanadium dioxide is the insulation phase at the temperature lower than the phase transition temperature. Therefore, at the temperature lower than the phase transition temperature, the switching element is in an off state. The vanadium dioxide is the metal phase at the temperature higher than the phase transition temperature. Therefore, at the temperature higher than the phase transition temperature, the switching element is in an on state. The resistance change in the phase transition of the insulation phase-metal phase of the vanadium dioxide indicates the hysteresis characteristics. Therefore, in consideration of the hysteresis characteristics, the temperature of the phase transition layer V is adjusted in such a way as to cross the phase transition temperature.

The heat generation element H has the similar configuration to that of the heat generation element H of the first example embodiment. The heat generation element H is arranged on an upper surface of the heat conduction promotion layer 54. The heat generation element H and the phase transition layer V are arranged above the substrate 51. The heat generation element H is arranged at an interval from the phase transition layer V. The heat generation element H has the elongated rectangular shape along the direction perpendicular to the extension direction of the phase shift wiring 50-2. The heat generation element H is smaller than the phase transition layer V. The temperature of the heat generation element His controlled according to the selection via the TFT circuit (not illustrated). The heat generation element H is connected to the drive circuit (not illustrated) constituting the TFT circuit by the temperature control line. The TFT wiring includes the plurality of selection lines and the plurality of data lines. The two heat generation elements H constituting the heat generation element pair are connected to the same drive circuit. When the drive circuit connected to the two paired heat generation elements H is selected, the heat generation elements H generate heat. The heat of the heat generation elements H is conducted to the phase transition layer V via the heat conduction promotion layer 54 and the heat conduction layer 52 arranged on the lower surfaces of the heat generation elements H. The resistance change in the phase transition of the insulation phase-metal phase of the vanadium dioxide indicates the hysteresis characteristics. Therefore, in consideration of the hysteresis characteristics, the temperature of the heat generation element H is controlled in such a way that the temperature of the phase transition layer V crosses the phase transition temperature.

A line length of the phase shift wiring 50-2 is set according to selection control of the heat generation element H. The heat conduction layer 52 and the phase transition layer V are arranged across the plurality of switching elements. The phase transition layer V is thermally connected to the heat generation element H via the heat conduction layer 52. The phase transition layer V generates heat according to a selection situation of the plurality of heat generation elements H.

When the selection switch arranged at the contact point with the main wiring is selected and the transition to the on state is performed, the phase shift wiring 50-2 connected to the main wiring via the selection switch transitions to an on state. When the heat generation element H connected to the phase shift wiring 50-2 generates heat, the heat is conducted to the phase transition layer V via the heat conduction promotion layer 54 and the heat conduction layer 52 thermally connected to the heat generation element H. When the temperature of the phase transition layer V exceeds the phase transition temperature of the insulation phase-metal phase, the phase transition layer V transitions to the metal phase. The phase transition layer V that has undergone the phase transition to the metal phase functions as the line of the phase shift wiring.

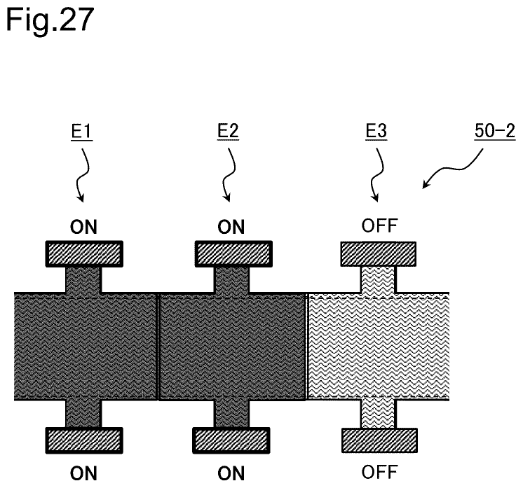

FIG. 27 is a conceptual diagram illustrating an example of the heat conduction in the extension structure of the phase shifter in the present disclosure. FIG. 27 illustrates the three switching elements. In the example of FIG. 27, the portion of the phase transition layer V in the insulation phase state and the portion of the phase transition layer V in the metal phase state are indicated by different hatching. The switching element E1 and the switching element E2 are in the on state. The phase transition layer V in the portions of the switching element E1 and the switching element E2 is in the metal phase state. The switching element E3 is in the off state. The phase transition layer V in the portion of the switching element E3 is in the insulation phase state. In a case where there is the contact point with the main wiring on the left side (drawing) of the phase shift wiring 50-2, the line length of the phase shift wiring 50-2 extends from the contact point with the main wiring (not illustrated) to the switching element E2. In the present configuration example, the heat conduction promotion layer 54 constituting the adjacent switching elements is divided. In the present configuration example, since the heat conduction promotion layer 54 has the higher thermal conductivity than that of the heat conduction layer 52, the heat of the heat generation element H is easily conducted to the heat conduction promotion layer 54. Therefore, according to the present configuration example, the heat of the heat generation element H for heating the adjacent switching elements is hardly conducted to the portion of the phase transition layer V positioned at the boundary between the switching element E1 and the switching element E2.

A phase of a signal propagated from the signal source (not illustrated) to the patch antenna (not illustrated) via the phase shift wiring 50-2 undergoes the phase shift according to the line length of the phase shift wiring 50-2 that has undergone the phase transition to the metal phase. When the temperature of the phase transition layer V falls below the phase transition temperature of the insulation phase-metal phase, the phase transition layer V undergoes the phase transition to the insulation phase, and the line length of the phase shift wiring 50-2 becomes short. When the transition is performed to the off state where the selection switch arranged at the contact point with the main wiring is deselected, the phase shift wiring 50-2 connected to the main wiring via the selection switch transitions to an off state.

As described above, the phase shifter of the present example embodiment can achieve the extension structure in which the switching elements of the first to fourth example embodiments are extended along the uniaxial direction. By using the extension structure of the present example embodiment, the phase shifter having the variable line length can be achieved.

### Sixth Example Embodiment

Next, an antenna device according to a sixth example embodiment will be described with reference to the drawings. The antenna device of the present disclosure includes a planar antenna including the phase shifter in the fifth example embodiment. The following configuration is an example, and does not limit a configuration of the antenna device of the present disclosure.

### (Configuration)

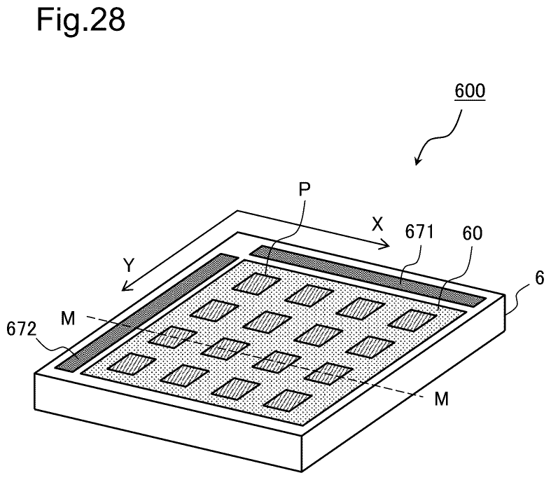

FIG. 28 is a conceptual diagram illustrating an example of the configuration of the antenna device in the present disclosure. FIG. 28 illustrates an example of an appearance of the antenna device in the present disclosure. An antenna device 600 includes a planar antenna 6. The planar antenna 6 includes the phase shifter of the fifth example embodiment. An antenna array 60 including a plurality of patch antennas P arrayed in a two-dimensional array shape is arranged on an upper surface of the planar antenna 6. The plurality of patch antennas P is arrayed along an X direction and a Y direction. The plurality of patch antennas P is phased arrayed. Each of the plurality of patch antennas P constitutes an antenna element. Each antenna element is independently controlled. The planar antenna 6 includes a TFT circuit (not illustrated) including a thin film transistor (TFT). The TFT circuit is used to select the patch antenna P used for transmission/reception of radio waves.

The antenna device 600 is mounted with a first drive circuit 671 and a second drive circuit 672. The first drive circuit 671 and the second drive circuit 672 are circuits used to select the patch antenna P to be driven. By driving the first drive circuit 671 and the second drive circuit 672, an address associated with each of the plurality of patch antennas P can be designated. For example, the first drive circuit 671 and the second drive circuit 672 are formed on the surface of the planar antenna 6. The first drive circuit 671 and the second drive circuit 672 may be formed inside the planar antenna 6.

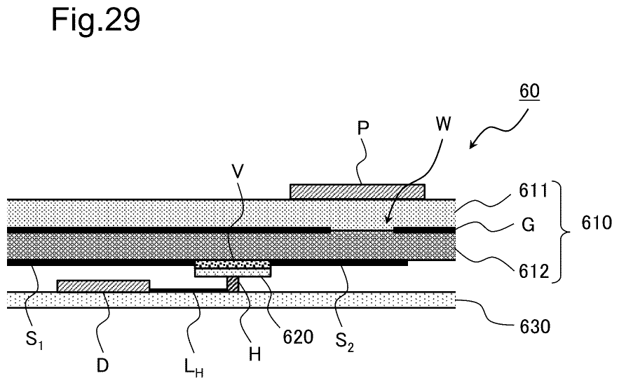

FIG. 29 is a conceptual diagram illustrating a cross section of a portion of the planar antenna included in the antenna device in the present disclosure. FIG. 29 illustrates the cross section of the planar antenna cut along a cutting line M-M illustrated in FIG. 28. FIG. 29 illustrates one of the plurality of antenna elements constituting the planar antenna. The planar antenna 6 includes an antenna substrate 610, a temperature control substrate 630, a phase transition layer V, a heat conduction layer 620, a heat generation element H, a drive circuit D, and the patch antenna P.

The antenna substrate 610 includes a first substrate 611 and a second substrate 612. The first substrate 611 and the second substrate 612 are insulators (dielectrics). The first substrate 611 and the second substrate 612 include a material having a low dielectric loss. The first substrate 611 and the second substrate 612 preferably include a raw material having a high insulating property and a low dielectric loss, such as a ceramic material or glass. The first substrate 611 and the second substrate 612 may include a polymer or a synthetic material. The lower the dielectric loss of the first substrate 611 and the second substrate 612, the more effectively electromagnetic waves such as high frequency waves and microwaves can be controlled. For example, at least one of the first substrate 611 and the second substrate 612 includes a multilayer substrate having a small transmission loss. For example, at least one of the first substrate 611 and the second substrate 612 may include an alumina substrate.

The patch antenna P is arranged on an upper surface of the first substrate 611. A ground layer G is arranged between a lower surface of the first substrate 611 and an upper surface of the second substrate 612. An opening W is formed in the ground layer G. The opening W is formed below the patch antenna P. The phase transition layer V is arranged on a lower surface of the second substrate 612.

The phase transition layer V has a similar configuration to that of the phase transition layer V of the first example embodiment. The phase transition layer V is arranged on the lower surface of the second substrate 612. The heat conduction layer 620 is arranged on a lower surface of the phase transition layer V. The phase transition layer V is thermally connected to the heat generation element H via the heat conduction layer 620. It is sufficient that the structure for thermally connecting the phase transition layer V and the heat generation element His similar to the structure of the switching element according to any one of the first to fourth example embodiments. For example, the heat conduction layer 620 may be arranged on the lower surface of the second substrate 612, and the phase transition layer V may be arranged on a lower surface of the heat conduction layer 620. To the phase transition layer V, heat generated from the heat generation element H is conducted via the heat conduction layer 620. The phase transition layer V undergoes a phase transition from an insulation phase to a metal phase by heat generation of the heat generation element H. The phase transition layer V is electrically connected to a first signal line S₁ and a second signal line S₂. The phase transition layer V is arranged between the first signal line S₁ and the second signal line S₂ and functions as a switch.

The first signal line S₁ and the second signal line S₂ connected to the phase transition layer V are arranged on the lower surface of the second substrate 612. The first signal line S₁ is connected to a signal source (not illustrated) via a phase shift wiring (not illustrated). The first signal line S₁ is a line through which a phase-shifted signal is propagated by the phase shift wiring. The second signal line S₂ is extended to below the patch antenna P. The second signal line S₂ is a line for propagating the phase-shifted signal after the phase shift to the patch antenna P. The opening W is interposed between the second signal line S₂ and the patch antenna P. A layer in which the phase transition layer V, the first signal line S₁, and the second signal line S₂ are arranged forms a phase shift layer.

The patch antenna P is a plate-shaped radiation element. For example, the patch antenna P has a square shape. The shape of the patch antenna P is not limited to the square shape, and may be a circular shape or other shapes. The patch antenna P is power fed by an electromagnetic coupling feeding method. The patch antenna P is electromagnetically coupled to the second signal line S₂ formed on the lower surface of the second substrate 612 via the opening W. The patch antenna P is excited by the electromagnetic coupling between the patch antenna P and the second signal line S₂ via the opening W. The patch antenna P has a structure equivalent to that of a microstrip line whose both ends are opened. A resonance frequency of the patch antenna P is an integral multiple of a wavelength related to a length of one side of the patch antenna P. A size of the patch antenna P is set according to a wavelength of a transmission target radio wave. The patch antenna P may be connected to the second signal line S₂ in a wired manner via an electric conductor. The patch antenna P may be formed on the same surface as the second signal line S₂ and may be directly connected to the second signal line S₂. In that case, the patch antenna P is configured in such a way that the phase shift wiring arranged in the phase shift layer and the second signal line S₂ are electromagnetically coupled.

The ground layer G is arranged between the first substrate 611 and the second substrate 612. The ground layer G may be formed on the lower surface of the first substrate 611 or may be formed on the upper surface of the second substrate 612. The ground layer G blocks electromagnetic coupling above and below the ground layer G. The ground layer G includes an electric conductor. For example, a raw material of the ground layer G is metal (including an alloy) such as copper, aluminum, or chromium. A potential of the ground layer G is a ground potential. Therefore, a capacitance according to a dielectric constant of the second substrate 612 is formed between the ground layer G and the phase shift layer that includes the phase transition layer V, the first signal line S₁, the second signal line S₂, and the phase shift wiring (not illustrated).

The temperature control substrate 630 is a substrate on which the TFT circuit is formed. For example, a raw material of the temperature control substrate 630 is an insulator (dielectric). The temperature control substrate 630 includes a material having a low dielectric loss. For example, the temperature control substrate 630 includes the raw material having a high insulating property and a low dielectric loss, such as ceramic material or glass. The temperature control substrate 630 may include a polymer or a synthetic material. The lower the dielectric loss of the temperature control substrate 630, the more effectively electromagnetic waves such as high frequency waves and microwaves can be controlled. For example, the temperature control substrate 630 includes a multilayer substrate having a small transmission loss. For example, the temperature control substrate 630 may include an alumina substrate.

The drive circuit D and the heat generation element H are arranged on an upper surface of the temperature control substrate 630. The drive circuit D and the heat generation element H are connected by a temperature control line LH. The drive circuit D is an element constituting the TFT circuit. A TFT wiring (not illustrated) for controlling a temperature of the heat generation element H is formed in the layer in which the heat generation element H is arranged. The TFT wiring includes a plurality of selection lines used to select the drive circuit D and a plurality of data lines used to write phase shift data to the phase shifter.

The heat generation element H has a similar configuration to that of the first example embodiment. The heat generation element His arranged on the upper surface of the temperature control substrate 630. The heat generation element H is arranged in such a way that an upper surface of the heat generation element His in contact with the heat conduction layer 620. The heat generation element H has an elongated rectangular shape along a direction perpendicular to an extension direction of the first signal line S₁ and the second signal line S₂. The heat generation element H is smaller than the phase transition layer V. The temperature of the heat generation element H is controlled according to selection via the TFT circuit (not illustrated). The heat generation element H is connected to the drive circuit D constituting the TFT circuit by the temperature control line LH. The TFT wiring includes the plurality of selection lines and the plurality of data lines. When the drive circuit D connected to the heat generation element H is selected, the heat generation element H generates heat. The heat of the heat generation element H is conducted to the phase transition layer V arranged above the heat generation element H via the heat conduction layer 620. A resistance change in the phase transition of the insulation phase-metal phase of a vanadium dioxide indicates hysteresis characteristics. Therefore, in consideration of the hysteresis characteristics, the temperature of the heat generation element His controlled in such a way that the temperature of the phase transition layer V crosses the phase transition temperature.

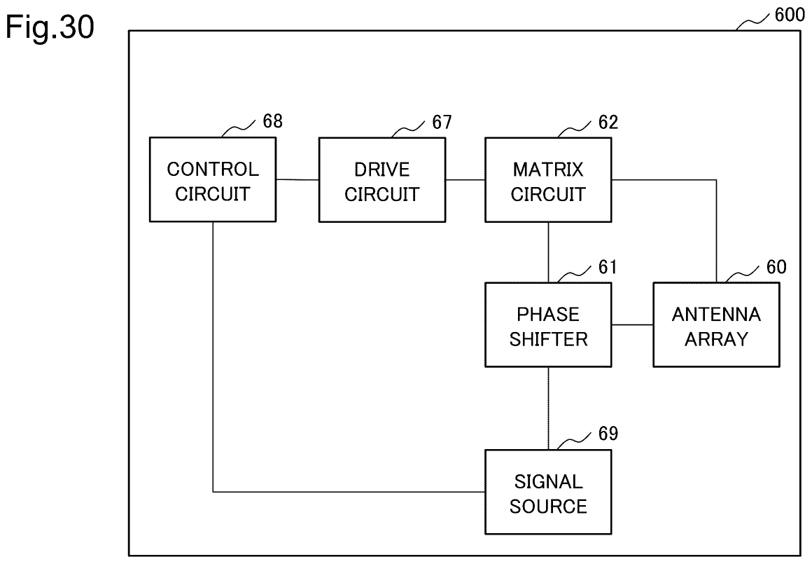

FIG. 30 is a block diagram illustrating an example of the configuration of the antenna device in the present disclosure. The antenna device 600 includes the antenna array 60, a phase shifter 61, a matrix circuit 62, a drive circuit 67, a control circuit 68, and a signal source 69.

The phase shifter 61 is configured for each patch antenna. The phase shifter 61 includes the phase shift wiring (not illustrated), the first signal line S₁, the second signal line S₂, the phase transition layer V, the heat generation element H, and the temperature control line LH. A phase shift amount of the phase shifter 61 is set according to a line length of a line formed by the phase shift wiring, the first signal line S₁, the second signal line S₂, and the phase transition layer V, and dielectric constants of the antenna substrate 610 and the temperature control substrate 630.

The matrix circuit 62 has a configuration in which a plurality of thin film transistors (TFTs) is arrayed in a two-dimensional array shape. The matrix circuit 62 is formed using a TFT process technology. For example, a shield layer is formed above the matrix circuit 62. The shield layer is formed to prevent electromagnetic coupling of above and below the shield layer. For example, the shield layer includes an electric conductor. A potential of the shield layer is basically a ground potential. Therefore, a capacitance according to a dielectric constant of a dielectric layer such as an insulation layer or a TFT substrate is formed between the signal lines included in the phase shifter 61 and the shield layer. Each of the plurality of TFTs included in the matrix circuit 62 is associated with any one of the plurality of patch antennas P included in the antenna array 60. For example, the TFT includes a semiconductor layer such as amorphous silicon or polysilicon.

The drive circuit 67 includes the first drive circuit 671 and the second drive circuit 672. The first drive circuit 671 is a circuit for performing addressing in the X direction. The first drive circuit 671 is connected to a plurality of lines extending in the Y direction. The second drive circuit 672 is a circuit for performing addressing in the Y direction. The second drive circuit 672 is connected to a plurality of lines extending in the X direction. The drive circuit 67 can designate the address associated with each patch antenna P by controlling the first drive circuit 671 and the second drive circuit 672. The drive circuit 67 drives the plurality of TFTs included in the matrix circuit 62 under the control of the control circuit 68. The drive circuit 67 individually drives the plurality of TFTs arrayed in the two-dimensional array shape.

The control circuit 68 drives the drive circuit 67 according to a control signal from the outside. The control circuit 68 drives the drive circuit 67 by an active matrix driving method. The control circuit 68 outputs the control signal from the outside to the signal source 69. For example, the control circuit 68 is achieved by a microcomputer or a microcontroller. For example, the control circuit 68 includes a processor, a memory, and the like. For example, the control circuit 68 includes a central processing unit (CPU), a random access memory (RAM), a read only memory (ROM), a flash memory, and the like. The control circuit 68 controls an operation of the antenna device 600 by causing the processor to execute a program stored in advance in the memory or the like. The control circuit 68 executes control according to the program according to a preset schedule or timing, an external control instruction, or the like. For example, the control circuit 68 controls the antenna array 60 including the plurality of patch antennas P included in the planar antenna 6 to transmit a radio wave having directivity from the antenna array 60. In this manner, the antenna array 60 is used as a phased array antenna.

The signal source 69 is connected to switches including a plurality of switching elements included in a plurality of antenna elements included in the phase shifter 61. The signal source 69 is connected to the control circuit 68. The signal source 69 acquires a control signal from the control circuit 68. The signal source 69 controls on/off of the plurality of switching elements constituting the switches according to the control signal. The signal source 69 may directly receive the control signal from the outside without passing through the control circuit 68.

A signal reaching a signal input unit of the phase shifter 61 through a signal line (not illustrated) connected to the TFT in an on state is phase-shifted by the line length set in the phase shifter 61 and the phase shift amount according to the dielectric constants of the dielectrics including the antenna substrate 610 and the temperature control substrate 630. The phase-shifted signal propagates from the second signal line S₂ to the patch antenna P by electromagnetic coupling. The signal propagated to the patch antenna P is transmitted from the patch antenna P as a transmission target radio wave. The radio wave transmitted from the patch antenna P is derived from a signal output from a transmission circuit (not illustrated). Information included in the signal is not particularly limited.

The radio wave received by the patch antenna P is received according to a capacitance based on the dielectric constant of the antenna substrate 610 interposed between the patch antenna P and the second signal line S₂. A phase of the received radio wave is shifted by the line length set in the phase shifter 61 and the phase shift amount according to the dielectric constants of the antenna substrate 610 and the temperature control substrate 630. The phase-shifted signal is received by a reception circuit (not illustrated) through the signal lines. Information included in the signal received by the reception circuit is decoded by a decoder (not illustrated).

As described above, the antenna device of the present example embodiment includes the planar antenna including the plurality of patch antennas. The planar antenna includes the antenna substrate and the temperature control substrate. On the antenna substrate, the antenna array including the plurality of patch antennas arrayed in the array shape and the switching element associated with each of the plurality of patch antennas are arranged. On the temperature control substrate, the drive circuit that drives the switching element associated with each of the plurality of patch antennas is arranged for each switching element. The switching element includes the phase transition layer, the heat conduction layer, and the heat generation element. The phase transition layer includes the substance that undergoes the metal-insulator phase transition. The phase transition layer is arranged in the signal lines through which the signals to be transmitted and received propagate. The heat conduction layer is the insulator having the higher thermal conductivity than that of the phase transition layer. The heat conduction layer is formed on the surface of the phase transition layer. The heat generation element has the rectangular shape having the long side along the direction perpendicular to the extension direction of the signal lines and the short side shorter than the side length of the phase transition layer. The heat generation element is thermally connected to the phase transition layer and the heat conduction layer.

The antenna device of the present example embodiment includes at least one of the switching elements of the first to fourth example embodiments. The switching element included in the antenna device of the present example embodiment can efficiently perform the phase transition of the phase transition layer even when the size of the heat generation element is reduced. Therefore, according to the present example embodiment, power consumption can be reduced. According to the configuration of the present example embodiment, since the signal lines and the heat generation element are arranged at the positions separated from each other, high-frequency coupling between the signal lines and the heat generation element hardly occurs. Therefore, according to the present example embodiment, the antenna device having high dielectric characteristics can be achieved.

By controlling the plurality of patch antennas included in the planar antenna included in the antenna device of the present example embodiment, it is possible to transmit a radio wave having directivity from the antenna array including the plurality of patch antennas. That is, the antenna array including the plurality of patch antennas can be used as the phased array antenna.

### Seventh Example Embodiment

Next, a switching element in a seventh example embodiment will be described with reference to the drawings. The switching element of the present example embodiment has a configuration in which the switching elements of the first to fourth example embodiments are simplified.

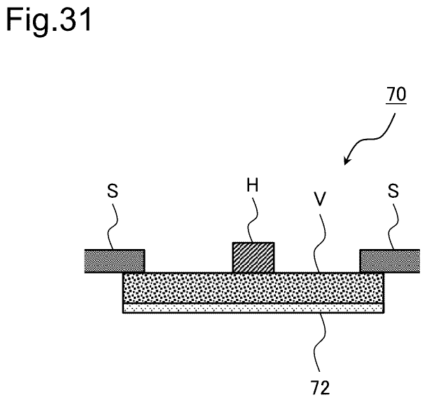

FIG. 31 is a conceptual diagram illustrating an example of a configuration of the switching element in the present disclosure. A switching element 70 includes a phase transition layer V, a heat conduction layer 72, and a heat generation element H.

The phase transition layer V includes a substance that undergoes a metal-insulator phase transition. The phase transition layer V is arranged on signal lines S through which signals to be transmitted and received propagate. The heat conduction layer 72 is an insulator having a higher thermal conductivity than that of the phase transition layer. The heat conduction layer 72 is formed on a surface of the phase transition layer. The heat generation element H has a rectangular shape having a long side along a direction perpendicular to an extension direction of the signal lines and a short side shorter than a side length of the phase transition layer. The heat generation element His thermally connected to the phase transition layer and the heat conduction layer.

The switching element of the present example embodiment includes the phase transition layer including the substance that undergoes the metal-insulator phase transition. The heat conduction layer having the higher thermal conductivity than that of the phase transition layer is formed on the surface of the phase transition layer. The phase transition layer and the heat conduction layer are thermally connected to the heat generation element. When the heat generation element generates heat, the phase transition layer is uniformly heated via the heat conduction layer formed on the surface. Therefore, according to the configuration of the present example embodiment, even when a size of the heat generation element is reduced, the phase transition layer including the substance that undergoes the metal-insulator phase transition can be efficiently subjected to a phase transition.

For example, functions of the components included in the switching element in the present example embodiment are achieved by the functions of the components included in the switching elements in the first to fourth example embodiments. For example, the switching element in the present example embodiment is applied to the extension structure of the phase shifter in the fifth example embodiment. For example, the switching element in the present example embodiment is controlled by the control system included in the antenna device in the sixth example embodiment.

### (Hardware)

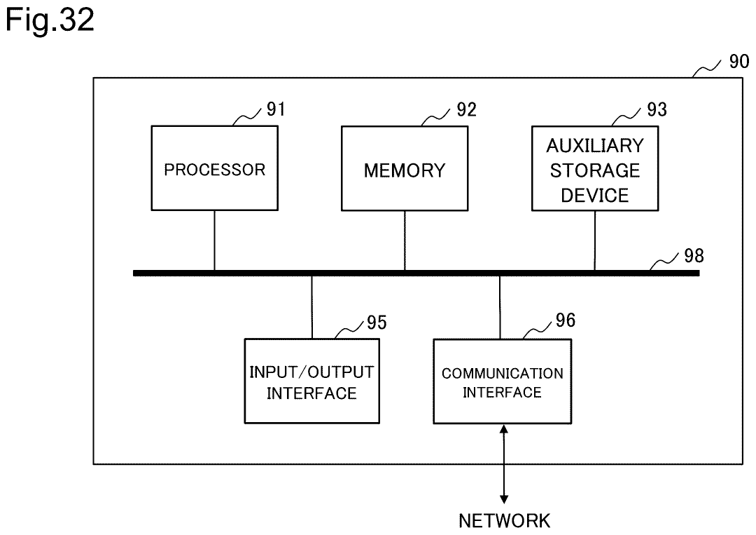

Next, a hardware configuration for executing control in the present disclosure will be described with reference to the drawings. FIG. 32 is a block diagram illustrating an example of the hardware configuration that executes the control in the present disclosure. Here, an information processing device 90 (computer) is illustrated as an example of the hardware configuration. The information processing device of FIG. 32 is the configuration example for executing the control in the present disclosure, and does not limit the scope of the present disclosure.

As illustrated in FIG. 32, the information processing device 90 includes a processor 91, a memory 92, an auxiliary storage device 93, an input/output interface 95, and a communication interface 96. In FIG. 32, the interface is abbreviated as an interface (I/F). The information processing device 90 may include a plurality of at least one of the processor 91, the memory 92, the auxiliary storage device 93, the input/output interface 95, and the communication interface 96. The processor 91, the memory 92, the auxiliary storage device 93, the input/output interface 95, and the communication interface 96 are data-communicably connected to each other via a bus 98. The processor 91, the memory 92, the auxiliary storage device 93, and the input/output interface 95 are connected to a network such as the Internet or an intranet via the communication interface 96.

The processor 91 develops a program (command) stored in the auxiliary storage device 93 or the like in the memory 92. For example, the program is a software program for executing the control in the present disclosure. The processor 91 executes the program developed in the memory 92. The processor 91 executes the control in the present disclosure by executing the program. The processor 91 may include a single piece of hardware or may include a plurality of pieces of hardware.

The memory 92 is a storage device having a region in which a program is developed. A program stored in the auxiliary storage device 93 or the like is developed in the memory 92 by the processor 91. The memory 92 is achieved by, for example, a volatile memory such as a dynamic random access memory (DRAM). A nonvolatile memory such as a magnetoresistive random access memory (MRAM) may be applied as the memory 92. The memory 92 may include a single piece of hardware or may include a plurality of pieces of hardware.

The auxiliary storage device 93 stores various types of data such as programs. For example, the auxiliary storage device 93 is achieved by a hard disk or a local disk such as a flash memory. The auxiliary storage device 93 may include a single piece of hardware or may include a plurality of pieces of hardware. The auxiliary storage device 93 may be configured as external hardware. Various types of data may be stored in the memory 92, and the auxiliary storage device 93 may be omitted.

The input/output interface 95 is an interface for connecting the information processing device 90 and a peripheral device in accordance with a standard or a specification. The communication interface 96 is an interface for connecting to an external system or device through a network such as the Internet or an intranet in accordance with a standard or a specification. The input/output interface 95 may include a single piece of hardware or may include a plurality of pieces of hardware. The input/output interface 95 and the communication interface 96 may be shared as an interface connected to an external device.

Input devices such as a keyboard, a mouse, and a touch panel may be connected to the information processing device 90 as necessary. These input devices are used to input information and settings. In a case where the touch panel is used as the input device, a screen having a touch panel function serves as an interface. The processor 91 and the input device are connected via the input/output interface 95.

The information processing device 90 may be provided with a display device for displaying information. In a case where the display device is provided, the information processing device 90 includes a display control device (not illustrated) for controlling display of the display device. The information processing device 90 and the display device are connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via the input/output interface 95.

The above is an example of the hardware configuration for enabling the control in the present disclosure. The hardware configuration of FIG. 32 is an example of the hardware configuration for executing the control in the present disclosure, and does not limit the scope of the present disclosure. A program for causing a computer to execute the control in the present disclosure is also included in the scope of the present disclosure.

A program recording medium in which a program for executing processing in the present example embodiment is recorded is also included in the scope of the present invention. For example, the program recording medium is a computer-readable non-transitory recording medium. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. The recording medium may be achieved by a magnetic recording medium such as a flexible disk, or other recording media.

The components in the present disclosure may be combined in any manner. The components in the present disclosure may be achieved by software. The components in the present disclosure may be achieved by a circuit.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

A part or all of the above-described example embodiments may also be described as the following Supplementary Notes, but are not limited to the following Supplementary Notes.

### (Supplementary Note 1)

A switching element including:
a phase transition layer that includes a substance that undergoes a metal-insulator phase transition and is arranged on signal lines through which signals to be transmitted and received propagate;
a heat conduction layer that is an insulator having a thermal conductivity higher than a thermal conductivity of the phase transition layer and is formed on a surface of the phase transition layer; and
a heat generation element that has a rectangular shape having a long side along a direction perpendicular to an extension direction of the signal lines and a short side shorter than a side length of the phase transition layer, and that is thermally connected to the phase transition layer and the heat conduction layer.

### (Supplementary Note 2)

The switching element according to Supplementary Note 1, in which
the phase transition layer
includes a vanadium dioxide as the substance that undergoes the metal-insulator phase transition.

### (Supplementary Note 3)

The switching element according to Supplementary Note 2, in which the phase transition layer is arranged between the heat generation element and the heat conduction layer.

### (Supplementary Note 4)

The switching element according to Supplementary Note 2, in which the heat conduction layer is arranged between the phase transition layer and the heat generation element.

### (Supplementary Note 5)

The switching element according to Supplementary Note 3 or 4, further including a heat conduction promotion layer that is an insulator having a higher thermal conductivity than the thermal conductivity of the heat conduction layer, and is thermally connected to the phase transition layer.

### (Supplementary Note 6)

The switching element according to Supplementary Note 3 or 4, in which the phase transition layer is connected to the signal lines via metal vanadium.

### (Supplementary Note 7)

The switching element according to Supplementary Note 2, in which the phase transition layer and the heat generation element are arranged at an interval on the same surface of the heat conduction layer.

### (Supplementary Note 8)

The switching element according to Supplementary Note 7, in which at least one of the phase transition layer, the heat generation element, and the heat conduction layer is covered with a heat conduction promotion layer that is an insulator having a higher thermal conductivity than the thermal conductivity of the heat conduction layer.

### (Supplementary Note 9)

The switching element according to Supplementary Note 2, further including
a heat conduction promotion layer that is an insulator having a higher thermal conductivity than the thermal conductivity of the heat conduction layer, and is thermally connected to the phase transition layer,
in which the phase transition layer and the heat generation element are arranged at an interval on a side of the same surface of the heat conduction promotion layer.

### (Supplementary Note 10)

A planar antenna including:
an antenna substrate on which an antenna array and a switching element are arranged, the antenna array including a plurality of patch antennas arranged in an array shape, the switching element being associated with each of the plurality of patch antennas; and
a temperature control substrate on which a thin film transistor circuit that controls a temperature of the switching element associated with each of the plurality of patch antennas is arranged,
the switching element including:
a phase transition layer that includes a substance that undergoes a metal-insulator phase transition and is arranged on signal lines through which signals to be transmitted and received propagate;
a heat conduction layer that is an insulator having a thermal conductivity higher than a thermal conductivity of the phase transition layer and is formed on a surface of the phase transition layer; and
a heat generation element that has a rectangular shape having a long side along a direction perpendicular to an extension direction of the signal lines and a short side shorter than a side length of the phase transition layer, and that is thermally connected to the phase transition layer and the heat conduction layer.

1. A switching element comprising:
a phase transition layer that includes a substance that undergoes a metal-insulator phase transition and is arranged on signal lines through which signals to be transmitted and received propagate;
a heat conduction layer that is an insulator having a thermal conductivity higher than a thermal conductivity of the phase transition layer and is formed on a surface of the phase transition layer; and
a heat generation element that has a rectangular shape having a long side along a direction perpendicular to an extension direction of the signal lines and a short side shorter than a side length of the phase transition layer, and that is thermally connected to the phase transition layer and the heat conduction layer.

2. The switching element according to claim 1, wherein
the phase transition layer includes a vanadium dioxide as the substance that undergoes the metal-insulator phase transition.

3. The switching element according to claim 2, wherein
the phase transition layer is arranged between the heat generation element and the heat conduction layer.

4. The switching element according to claim 2, wherein
the heat conduction layer is arranged between the phase transition layer and the heat generation element.

5. The switching element according to claim 3, further comprising
a heat conduction promotion layer that is an insulator having a higher thermal conductivity than the thermal conductivity of the heat conduction layer, and is thermally connected to the phase transition layer.

6. The switching element according to claim 3, wherein
the phase transition layer is connected to the signal lines via metal vanadium.

7. The switching element according to claim 2, wherein
the phase transition layer and the heat generation element are arranged at an interval on the same surface of the heat conduction layer.

8. The switching element according to claim 7, wherein
at least one of the phase transition layer, the heat generation element, and the heat conduction layer is covered with a heat conduction promotion layer that is an insulator having a higher thermal conductivity than the thermal conductivity of the heat conduction layer.

9. The switching element according to claim 2, further comprising
a heat conduction promotion layer that is an insulator having a higher thermal conductivity than the thermal conductivity of the heat conduction layer, and is thermally connected to the phase transition layer, wherein
the phase transition layer and the heat generation element are arranged at an interval on a side of the same surface of the heat conduction promotion layer.

10. A planar antenna comprising:
an antenna substrate on which an antenna array and a switching element are arranged, the antenna array including a plurality of patch antennas arranged in an array shape, the switching element being associated with each of the plurality of patch antennas; and
a temperature control substrate on which a drive circuit that drives the switching element associated with each of the plurality of patch antennas is arranged for each switching element, wherein
the switching element includes
a phase transition layer that includes a substance that undergoes a metal-insulator phase transition and is arranged on signal lines through which signals to be transmitted and received propagate,
a heat conduction layer that is an insulator having a thermal conductivity higher than a thermal conductivity of the phase transition layer and is formed on a surface of the phase transition layer, and
a heat generation element that has a rectangular shape having a long side along a direction perpendicular to an extension direction of the signal lines and a short side shorter than a side length of the phase transition layer, and that is thermally connected to the phase transition layer and the heat conduction layer.
